(19) United States
(12) Patent Application Publication
(10) Pub. No.: US 2003/0207218 A1
(43) Pub. Date: Nov. 6, 2003

(54) Silver salt photothermographic dry imaging material

(76) Inventors: Takayuki Sasaki, Tokyo (JP); Tadashi Arimoto, Tokyo (JP); Kenji Ohnuma, Tokyo (JP)

Correspondence Address: MUSERLIAN AND LUCAS AND MERCANTI, LLP, 600 THIRD AVENUE, NEW YORK, NY, 10016, US

(21) Appl. No.: 10/417,610

(22) Filed: Apr. 17, 2003

(30) Foreign Application Priority Data
Apr. 25, 2002 (JP) JP2002-123822

(51) Int. Cl. G03C 1/498; G03C 1/93

(52) U.S. Cl. 430/534; 430/350; 430/533; 430/619

(57) ABSTRACT

A photothermographic imaging material comprising a support having thereon a sublayer and a photosensitive layer in the order, the photosensitive layer comprising photosensitive silver halide grains, light-insensitive organic silver salt grains, a binder, and a reducing agent for silver ions, wherein the sublayer comprises: (i) a first polymer selected from the group consisting of a polyester and a polyester derivative; and (ii) a second polymer selected from the group consisting of a vinyl polymer latex, a water-soluble polymer containing a vinyl polymer component, a styrene-diolefin copolymer and a polyurethane.

### TECHNICAL FIELD

The present invention relates to a silver salt photothermographic dry imaging material which comprises a support having thereon an image forming layer comprising organic silver salts, light-sensitive silver halide, reducing agents, and binders, and in more detail to a silver salt photothermographic dry imaging material having the aforesaid structure which comprises an improved non-image forming sublayer.

### BACKGROUND

Heretofore, in the medical and graphic arts fields, effluent resulting from wet processing for image forming materials has caused problems regarding workability. In recent years, from the viewpoint of environmental protection as well as space saving, a decrease in the aforesaid processing effluent has been increasingly sought. As a result, techniques have been needed, which relate to dry type photothermographic materials which are environmentally friendly, can be effectively exposed employing laser imagers and laser image setters, and can form clear black images exhibiting high resolution.

As described in, for example, U.S. Pat. Nos. 3,152,904 and 3,487,075, and D. Morgan et al., “Dry Silver Photographic Materials”, (Handbook of Imaging Materials, Marcel Dekker, Inc. page 48, 1991), as such techniques, silver salt photothermographic dry imaging materials have been known which comprise a support having thereon organic silver salts, light-sensitive silver halide grains and reducing agents. Since solution-based processing chemicals are not completely employed for the aforesaid silver salt photothermographic dry imaging materials, they exhibit advantages in that it is possible to provide a simpler environmentally friendly system to customers.

These silver salt photothermographic dry imaging materials comprise a support having thereon a light-sensitive layer (hereinafter also referred to as an image forming layer or an EC layer) and a backing layer (hereinafter also referred to as a BC layer). The aforesaid light-sensitive layer comprises light-sensitive silver halide as a photo-sensor and when thermally developed, commonly at 80 to 140° C., images are formed employing incorporated reducing agents while utilizing organic silver salts as a supply source of silver ions, while the aforesaid backing layer comprises dyes to absorb laser beams. It is essential that these layers firmly adhere to the support not only prior to thermal development but also after the same.

On the other hand, when a silver salt photothermographic dry imaging material is designed, considerations specific to thermal development are sought which are different from light-sensitive materials which are developed employing conventional photographic processing solutions. Particularly, during thermal development, a higher temperature, commonly from 80 to 140° C., is employed compared to the process in which the conventional photographic processing solutions are employed. Therefore, enhanced adhesion properties, as well as enhanced layer strength of each layer are required which are different from conventional aspects.

Specifically, the image forming layer immediately after thermal development tends to undergo layer peeling, as well as abrasion, which frequently causes problems. Further, thermal development tends to result in uneven development. The uneven development, specific to thermal development, is a critical problem in terms of image quality, since it can result in misdiagnoses. As a result, it has been sought to minimize the uneven development.

### SUMMARY

In order to overcome the drawbacks noted above, the present invention was achieved.

Namely, an object of the present invention is to provide a silver salt photothermographic dry imaging material which minimizes peeling of an image forming layer from its support as well as to prevent abrasion immediately after thermal development, and also minimizes uneven development specific to thermal development.

The inventors of the present invention conducted diligent investigations to overcome the aforesaid problems. As a result, it was discovered that the object of the present invention can be achieved employing any of the embodiments described below.

(1) According to one embodiment of the present invention, a photothermographic imaging material is provided, the photothermographic imaging material comprises a support having thereon a sublayer and a photosensitive layer in the order, the photosensitive layer comprising photosensitive silver halide grains, light-insensitive organic silver salt grains, a binder, and a reducing agent for silver ions,

wherein the sublayer comprises:

(i) a first polymer selected from the group consisting of a polyester and a polyester derivative; and

(ii) a second polymer selected from the group consisting a vinyl polymer latex, a water-soluble polymer containing a vinyl polymer component, a styrene-diolefin copolymer and a polyurethane.

(2) In another embodiment, the photothermographic imaging material of item (1) is provided, wherein the second polymer is a vinyl polymer latex.

(3) In another embodiment, the photothermographic imaging material of item (2) is provided,

wherein the first polymer is a polyester derivative which is modified with a vinyl monomer.

(4) In another embodiment, the photothermographic imaging material of item (3) is provided,

wherein a content of the vinyl monomer in the polyester derivative may be at least 10 weight % based on the total weight of the polyester derivative.

(5) In another embodiment, the photothermographic imaging material of item (1) is provided,

wherein the second polymer is a water-soluble polymer containing a vinyl polymer component.

(6) In another embodiment, the photothermographic imaging material of item (1) is provided,

wherein the second polymer is a styrene-diolefin copolymer.

(7) In another embodiment, the photothermographic imaging material of item (1) is provided,

wherein the second polymer is a polyurethane.

(8) In another embodiment, the photothermographic imaging material of item (1) is provided,

wherein the sublayer may further comprise an inorganic filler.

(9) In another embodiment, a photothermographic imaging material is provided, the photothermographic imaging material comprising a support having thereon a sublayer and a photosensitive layer in the order, the photosensitive layer comprising photosensitive silver halide grains, light-insensitive organic silver salt grains, a binder, and a reducing agent for silver ions,

wherein the sublayer comprises a polyester which is derived from a naphthalene dicarboxylic acid and an alcohol.

(10) In another embodiment, the photothermographic imaging material of item (9) is provided,

wherein the sublayer may further comprise an inorganic filler.

### DESCRIPTION OF THE PREFERRED EMBODIMENTS

The present invention will now be described. Initially, techniques are described which are common to form the first invention to the eighth invention (hereinafter referred to as the present invention, unless otherwise specified). Employed as common techniques may be those known in the art.

(Support)

Listed as components of supports (which hereinafter refer to the supports according to the present invention) which are usable in the silver salt photothermographic dry imaging material of the present invention are various types of high molecular materials, glass, wool, cotton fabric, paper, and metal such as aluminum. Preferred as supports are those which are flexible and can be wound up in the form of a roll.

Plastic film is employed which includes, for example, cellulose acetate film, polyester film, polyethylene terephthalate film, polyethylene naphthalate film, polyamide film, polyimide film, cellulose triacetate film, and polycarbonate film).

When the silver salt photothermographic dry imaging material of the present invention is employed for medical use, a 70 to 180 μm thick biaxially oriented thermally fixed polyethylene terephthalate film tinted with blue is preferred. It is possible to employ a technique described in paragraphs of ┌0030┘ through ┌0034┘ of Japanese Patent Application Open to Public Inspection No. 2001-22026 in the present invention.

Polyesters of preferred polyester supports refer to polymers which are prepared employing condensation polymerization of diols with dicarboxylic acids. Represented as dicarboxylic acids are, for example, terephthalic acid, isophthalic acid, phthalic acid, naphthalenedicarboxylic acid, adipic acid, and sebacic acid. Diols are represented, for example, by ethylene glycol, trimethylene glycol, tetramethylene glycol, and cyclohexanedimethanol. Specifically listed are, for example, polyethylene terephthalate, polyethylene-p-oxybenzoate, poly-1,4-cyclohexylene dimethylene phthalate, polyethylene-2,6-naphthalene dicarboxylate. In the case of the present invention, polyethylene terephthalate as well as polyethylene naphthalate is particularly preferred.

Polyethylene terephthalate film exhibits excellent water resistance, durability and chemical resistance. Needless to say, such polyester may be either homopolyester or copolyester. Listed as copolymerizing components may be diol components such as diethylene glycol, neopentyl glycol, and polyalkylene glycol and dicarboxylic acid components such as adipic acid, sebacic acid, phthalic acid, 2,6-naphthalenedicarboxyic acid, and sodium 5-sulfoisophthalate.

In these polyester supports, minute particles of calcium carbonate, non-crystalline zeolite, anatase type titanium dioxide, calcium phosphate, silica, kaolin, talc, and clay may be employed in combination. The added amount of these particles is preferably 0.0005 to 25 parts by weight with respect to 100 parts by weight of the polyester composition.

Further, other than such minute particles, it is possible to use, in combination, minute particles which are deposited through the reaction of catalyst residues with phosphorous compounds in a polyester polymerization condensation reaction system. Listed as minute deposit particles may be, for example, particles comprised of calcium, lithium, and phosphorous compounds or particles comprised of magnesium and phosphorous compounds.

The proportion of such particles in polyester is preferably 0.05 to 1.00 part by weight with respect to 100 parts by weight of the polyester.

From the viewpoint of mechanical strength as well as runnability, the thickness of polyester supports is preferably 10 to 250 μm, and is more preferably 15 to 200 μm.

In order to reduce roll-set curl, as described in Japanese Patent Application Open to Public Inspection No. 51-16358, after casting, a polyester support may be subjected to a thermal treatment in the temperature range of less than or equal to the glass transition temperature for 0.1 to 1,500 hours.

In order to enhance adhesion properties, if desired, polyester supports may be subjected to surface treatments known in the art such as chemical treatments (described in Japanese Patent Publication Nos. 34-11031, 38-22148, 40-2276, 41-16423, and 44-5116), chemical and mechanical surface roughening treatments (described in Japanese Patent Publication Nos. 47-19068 and 55-5104), corona discharge treatments (described in Japanese Patent Publication No. 39-12838 and Japanese Patent Application Open to Public Inspection Nos. 47-19824 and 48-28067), flame treatments (Japanese Patent Publication No. 40-121384 and Japanese Patent Application Open to Public Inspection No. 48-85126), ultraviolet radiation treatments (described in Japanese Patent Publication Nos. 36-18915, 37-14493, 43-2603, 43-2604, and 52-24726), high frequency treatments (described in Japanese Patent Publication No. 49-10687), and glow discharge treatments (described in Japanese Patent Publication No. 37-17682), and in addition, active plasma treatments and laser treatments may be employed. As described in Japanese Patent Publication No. 57-487, it is preferable that the contact angle of the support surface to water is adjusted to at most 58 degrees. Further, polyester may be either transparent or opaque or may be tinted.

(Surface Treatment)

It is preferable that the support according to the present invention is subjected to a corona discharge treatment. The discharge amount is preferably controlled to be 5 to 30 W/m²·minute. It is preferable that a sublayer according to the present invention is applied to the corona treated supports within one to two months after the corona treatment.

The support according to the present invention may be subjected to a plasma surface treatment. The plasma treatment is preferred to be at approximately atmospheric pressure is preferred. When plasma discharge is carried out, preferred as gases for the treatment are those which are capable of providing functional groups such as an amino group, a carboxyl group, a hydroxyl group, or a carbonyl group. The gases include, for example, nitrogen (N₂) gas, hydrogen (H₂) gas, oxygen (O₂) gas, carbon dioxide (CO₂) gas, ammonia (NH₃) gas, and water vapor.

Further, other than reaction gases, inert gases such as argon are necessary and by maintaining the mixing ratio of inert gases at more than or equal to 60 percent, stable discharge conditions are achieved. However, when plasma is generated in a pulsed electric field, inert gases are not always necessary, while it is possible to increase the concentration of reaction gases. The frequency of the pulse electric field is preferably in the range of 1 to 100 kHz. Time applied to one pulse electric filed is preferably 1 to 1,000 μs, and voltage applied to the electrode is preferably in a range which results in an electric field strength of 1 to 100 kV/cm.

(Sublayer)

If desired, polymers other than polyesters may be incorporated in the sublayer. Employed as polymers are water-soluble polymers such as gelatin and polyvinyl alcohol, as well as hydrophobic polymers such as polyethyl acrylate, vinylidene chloride, and polyurethane without particular limitations.

Further, the sublayer need not always be comprised of a single layer. When comprised of a plurality of layers, in the case of the present invention in which a polyester component and vinyl based polymer latex are incorporated, a structure is particularly preferable in which both are incorporated in the same layer.

The thickness of the sublayer of the present invention is preferably 0.05 to 5 μm per layer, and is more preferably 0.1 to 3 μm.

(Polyester)

Polyester employed in the present invention is preferably a polyester copolymer which is soluble or dispersible in water. Such polyester is occasionally called hydrophilic polyester in the description of the present invention.

Listed as hydrophilic polyester copolymers may be hydrophilic polymers described, for example, in U.S. Pat. Nos. 4,252,885, 4,241,169, and 4,394,442; European Patent Nos. 29,620 and 78,559; Japanese Patent Application Open to Public Inspection No. 54-43017; and Research Disclosure 18928. Listed as hydrophilic polyesters are, for example, substantially linear polymers which are prepared by allowing polybasic acids or ester forming derivatives thereof to react with polyols, or ester forming derivatives thereof, employing polymerization condensation reaction schemes.

Employed as polybasic acid components which form a basic skeleton for the aforesaid polyester copolymers may be, for example, terephthalic acid, isophthalic acid, phthalic acid, phthalic anhydride, 2,6-napthalenedicarboxylic acid, 1,4-cyclohexanedicaroboxyic acid, adipic acid, sebacic acid, trimellitic acid, pyromellitic acid and dimeric acid. Along with these components, it is possible to employ a small proportion of unsaturated polybasic acids such as maleic acid, fumaric acid, and itaconic acid as well as hydroxylcarboxylic acids such as p-hydroxybenzoic acid and p-(β-hydroxyethoxy)benzoic acid. Of the aforesaid compounds, preferred as polybasic acid components are those which have terephthalic acid and isophthalic acid as a major dicarboxylic acid component. Further, the mol ratio of terephthalic acid to isophthalic acid is preferably 30/70 to 70/30 from the viewpoint of coatability onto polyester supports, as well as water solubility. Further, it is preferable that such terephthalic acid component and isophthalic acid component are incorporated in an amount of 50 to 80 mol percent with respect to all the dicarboxylic acid components.

In order to achieve polyester water solubility, an effective means is that components having a hydrophilic group such as a component having a sulfonic acid salt, a diethylene glycol component, a polyalkylene ether glycol component, or a polyether dicarboxylic acid component are introduced into the polyester as a copolymerization component. Specifically, in order to introduce a component having a hydrophilic group, it is preferable to use dicarboxylic acid having sulfonic acid salt as a monomer.

Particularly preferred as the aforesaid dicarboxylic acids having sulfonic acid salt are those having a group of a sulfonic acid alkali metal salt, which include, for example, alkali metal salts of 4-sulfophthalic acid, 5-sulfoisophthalic acid, sulfoterephthalic acid, 4-sulfophthalic acid, 4-sulfonaphthalene-2,7-dicarboxylic acid, and 5-(4-silfophenoxy)isophthalic acid. From the viewpoint of water solubility and water resistance, those dicarboxylic acids having a sulfonic acid salt are preferably employed in an amount of 5 to 20 mol percent with respect to the total dicarboxylic acid components and are more preferably in the range of 6 to 10 mol percent.

Further, it is preferable that in water-soluble polyesters in which terephthalic acid as well as isophthalic acid is employed as major dicarboxylic components, aliphatic dicarboxylic acids are employed as a copolymerization component. Listed as such aliphatic dicarboxylic acids may be, for example, 1,4-cyclohexanedicarboxyluc acid, 1,3-cylcohexanedicarboxylic acid, 1,2-cyclohexanedicarboxylyic acid, 1,3-cyclopentanedicarboxyluic acid, and 4,4′-bicylohexyldicaroxylic acid.

Further, it is possible to employ, as a copolymerization component, dicarboxylic acids other than those described above in hydrophilic polyester copolymers in which terephthalic acid as well as isophthalic acid is employed as a major dicarboxylic acid component. Listed as such dicarboxylic acids are, for example, aromatic dicarboxylic acids and straight chain-aliphatic dicarboxylic acids. It is preferable that aromatic dicarboxylic acids are employed in the range of at most 30 mol percent with respect to the total dicarboxylic acid components. Listed as such aromatic dicarboxylic acid components are, for example, phthalic acid, 2,5-dimethylterephthalic acid, 2,6-naphthalenedicarboxylic acid, 1,4-naphthalenedicarboxylic acid, and biphenyldicarboxylic acid. Further, it is preferable that straight-chain aliphatic dicarboxylic acids are employed in the range of at most 15 mol percent with respect to the total dicarboxylic acid components. Listed as such straight-chain aliphatic dicarboxylic acids are, for example, adipic acid, pimelic acid, suberic acid, azelaic acid, and sebacic acid.

Employed as polyol components may be ethylene glycol, diethylene glycol, 1,4-butanediol, neopentyl glycol, dipropylene glycol, 1,6-hexanediol, 1,4-cyclohexanedimethanol, xylene glycol, trimethylolpropane, poly(ethylene oxide)glycol, and poly(tetramethylene oxide)glycol.

Further, preferred as glycol components of hydrophilic polyester copolymers may be ethylene glycol, 1,4-butnanediol, neopentyl glycol, 1,4-cyclohexanedimethanol, diethylene glycol, triethylene glycol, and polyethylene glycol.

When hydrophilic polyester copolymers are prepared employing terephthalic acid and isophthalic acid as main dicarboxylic acid components, from the viewpoint of mechanical properties as well as adhesion properties to polyester supports, it is preferable to use ethylene glycol or diethylene glycol as glycol components of water-soluble polyester in an amount of at least 40 mol present of the total glycol components.

It is possible to synthesize hydrophilic polyester copolymers employing dicarboxylic acids or ester forming derivatives thereof and glycols or ester forming derivatives thereof as initial raw materials. Synthesis is carried out employing various methods which include, for example, an initial condensation product of dicarboxylic acids with glycols is prepared employing a transesterification method or a direct esterification method which subsequently is subjected to fusion polymerization.

Further, specifically, for example, an ester of dicarboxylic acid such as dicarboxylic acid dimethyl ester and glycol undergo transesterification and after removing methanol employing distillation, the pressure is gradually reduced and polymerization condensation is carried out under high vacuum. Other examples thereof include a method in which dicarboxylic acid and glycol undergo transesterification and further, after carrying out esterification by adding dicarboxylic acid, polymerization condensation is carried out under high vacuum.

Employed as transesterification catalysts and polymerization condensation catalysts may be any of the several known in the art. Employed as transesterification catalysts may be manganese acetate, calcium acetate and zinc acetate, while employed as polymerization condensation catalysts may be antimony trioxide, germanium oxide, dibutyl tin oxide, and titanium tetrabutoxide. However, polymerization methods as well as various conditions such as catalysts are not limited to the aforesaid examples.

Hydrophilic polyester copolymers may be prepared as described below.

While distilling methanol away, 35.4 parts by weight of dimethyl terephthalate, 33.63 parts by weight of dimethyl isophthalate, 17.92 parts by weight of dimethyl 5-sufoisophthalate sodium salt, 62 parts by weight of ethylene glycol, 0.065 part by weight of calcium acetate monohydrate, and 0.022 part by weight of manganese acetate underwent transesterification at a temperature of 170 to 220° C. under nitrogen gas stream, while methanol being distilled out. Thereafter, 0.04 part by weight of trimethyl phosphate, 0.04 part by weight of antimony trioxide, as a polymerization condensation catalyst and 6.8 parts by weight of 4-cyclohexanedicarboxylic acid were added and esterification was performed at a reaction temperature of 220 to 235° C., while the theoretical amount of water was substantially removed employing distillation. Thereafter, over approximately one hour, the pressure of the reaction system was reduced and polymerization condensation was carried out at 280° C. and 133 Pa for approximately one hour to obtain hydrophilic polyester. The obtained hydrophilic polyester exhibited an intrinsic viscosity of 0.33. Subsequently, the resulting copolymer was dispersed in pure water at 95° C. over 17 hours, whereby a hydrophilic polyester copolymer dispersion (having 15 percent solids) was obtained.

Further, commercially available hydrophilic polyester copolymers of the present invention include FPY6762, MPS7762, WD3652, WTL6342, WNT9515, WMS5115, WD, SIZE, WNT, and WHS (all being trade names), manufactured by Eastman Chemical Co. which are usable in the present invention. Hydrophilic polyesters.are described, for example, in “Suiyosei Kobunshi Mizu Bunsangata Jushi Sogo Shiryo Shu (Comprehensive Reference List of Water-Soluble Polymer Water-Dispersible Type Resins)”, (Keiei Kaihatsu Center, 1981).

Further, hydrophilic polyesters include VYLON 200 and 300 (manufactured by Toyo Boseki Co.), Finetex ES525, ES611, ES650, and ES675 (manufactured by Dainippon Ink Kagaku Kogyo Co.), KP-1019, KP-1027, and KP-1029 (manufactured by Matsumoto Yushi Seiyaku Co.), Plus Coat Z-446, 710, 711, 766, 770, 802, and 857 (manufactured by GOO Kagaku Kogyo Co.), and Pesresin A123D and A515 GB (manufactured by Takamatsu Yushi Co.).

The molecular weight of the polyester employed in the present invention is preferably 2,000 to 200,000 in terms of the weight average molecular weight Mw. Further, Tg is preferably −10 to 90° C. from the aspect of film forming properties and strength.

(Polyester Containing Hydrophilic Naphthalenedicarboxylic Acid)

It is preferable that the hydrophilic polyester resins of the present invention comprise naphthalenedicarboxylic acid as an acid component to enhance heat resistance. The proportion of such an acid component is preferably 40 to 90 mol percent with respect to the total acid components, and is more preferably 50 to 85 mol percent. A decrease in the proportion of such an acid component to less than 40 mol percent is not preferred since anti-blocking properties of an highly adhesive film is degraded due to a decrease in heat resistance of polyester resins. On the other hand, an increase in the aforesaid proportion to at least 90 percent is also not preferable, since it becomes difficult to prepare a water based composition of the aforesaid polyester resins due to the fact that during preparation of hydrophilic polyester resin solutions, it becomes difficult to dissolve the aforesaid polyester resin in hydrophilic organic solvents.

Listed as naphthalenedicarboxylic acids are 2,6-naphthalenedicarboxylic acid and 1,5-naphthalenedicarboxylic acid.

The hydrophilic polyester resins of the present invention have at least either a free carboxylic acid group or a carboxylic acid salt group in the molecule. In order to introduce the free carboxylic acid group into the polymer molecule, it is preferable to employ as one of several polymer production raw materials a multivalent compound such as trimellitic anhydride, trimellitic acid, pyromellitic anhydride, pyromellitic acid, trimecinic acid, cyclobutanetetracarboxylic acid, and dimethylolpropionic acid. Further, it is possible to introduce a carboxylic acid salt group by neutralizing a carboxylic acid group introduced into the polymer employing amino compounds, ammonia, or alkali metals (such as Li, Na, and K).

Further, when the carboxylic acid salt group is introduced, it is possible to employ any of the several other methods known in the art. For example, there is a method in which polyester is synthesized, employing compounds having a carboxylic acid salt group in the molecule as a raw material. For example, polyester having a free carboxyl group is prepared employing trimellitic anhydride as a polyester raw material, and after the completion of reaction, neutralization is carried out by adding ammonia water, whereby it is possible to prepare a polyester resin which is applied to the present invention.

The proportion of multivalent compounds, which introduce a free carboxylic acid group into the hydrophilic polyester resin, is preferably 0.5 to 20 mol percent with respect to the sum (200 mol percent) of the total acid components (100 mol percent) and the total polyol components (100 mol percent), and is more preferably 1 to 10 mol percent. When the aforesaid proportion is less than 0.5 mol percent, the resulting hydrophobicity decreases whereby it becomes difficult to dissolve the resulting resin in a water based solution. On the other hand, a proportion which exceeds 20 mol percent is not preferred due to a decrease in water resistance.

Exemplified as other acid components which constitute the hydrophilic polyester resins may be terephthalic acid, isophthalic acid, phthalic acid, phthalic anhydride, 1,4-cyclohexanedicarboxylic acid, adipic acid, sebacic acid, phenylindanedicarboxylic acid, and dimeric acid. These components may be employed in combination of at least two types. Further, it is possible to employ unsaturated polybasic acids such as maleic acid, fumaric acid, and itaconic acid or hydroxylcarboxylic acid such as p-hydroxybenzoic acid and p-(β-hydroxyethoxy)benzoic acid in a small proportion together with the aforesaid components. The proportion of unsaturated polybasic acid components or hydroxylcarboxylic acid components is at most 10 mol percent and is preferably less than or equal to 5 mol percent.

Further, exemplified as polyol components may be ethylene glycol, 1,4-butnaediol, neopentyl glycol, diethylene glycol, dipropylene glycol, 1,6-hexanediol, 1,4-cyclohexanedimethanol, xylene glycol, dimethylolpropionic acid, glycerin, trimethylolpropane, poly(ethyleneoxido)glycol, poly(tetramethyleneoxido)glycol, and in addition, ethylene oxide addition products of bisphenol A represented by the formula described below.

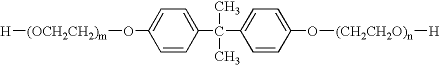

(wherein n+m=2 to 10)

Further, in order to somewhat enhance water solubility of the polyester, it is possible to copolymerize compounds having a sulfonic acid salt group in some amount. However, in order achieve excellent moisture resistance of the present invention, the employed amount of the compounds having a sulfonic acid salt group, which degrade moisture resistance, is naturally limited. Accordingly, equivalent of the sulfonic acid salt group is at most ½ with respect to the carboxylic acid salt group, and is preferably at most ⅕.

Listed as such sulfonic acid basic compounds are, for example, sulfonic acid alkali metal salt based or sulfonic acid amine salt based compounds such as 5-sodium sulfoisophthalic acid, 5-ammonium sulfoisophthalic acid, 4-sodium sulfoisophthalic acid, 4-methyl-ammonium sulfoisophthalic acid, 2-sodium sulfophthalic acid, 5-potassium sulfoisophthalic acid, 4-potassium sulfoisophthalic acid, 2-potassium sulfoisophthalic acid, and sodium sulfosuccininc acid.

The glass transition temperature (Tg) of hydrophilic polyester resins comprising naphthalenedicarboxylic acid of the present invention is preferably at least 50° C.

The hydrophilic polyester resins of the present invention can be produced employing conventional polyester solutions or fusion polymerization techniques. For example, it is possible to prepare the desired polyester resins employing the following production method. Initially, 2,6-naphthalenedicarboxylic acid or ester forming derivates thereof, isophthalic acid or ester forming derivatives thereof, and trimellitic acid or ester forming derivatives thereof are allowed to react with a mixture of ethylene glycol and ethylene oxide addition products of bisphenol A to form monomers or oligomers. Subsequently the resulting product undergoes polymerization condensation under vacuum to prepare polyester having the specified intrinsic viscosity (measured at 35° C. employing o-chlorophenol). During preparation, it is possible to use reaction accelerating catalysts such as esterification or transesterification catalysts or polymerization condensation catalysts. Further, various additives such as stabilizers may be added. The intrinsic viscosity of the polyester is preferably 0.2 to 0.8.

Methods to prepare a water based composition of hydrophilic polyester resins are exemplified below:

(1) The aforesaid polyester resins are dissolved in water or media comprised of water as a main component.

(2) The aforesaid polyester resins and water or media comprised of water as a main component are employed together with emulsifiers, dispersing agents, and suspension stabilizers to prepare an emulsion or a suspension.

(3) The aforesaid polyester resins are dissolved in media other than water and thereafter, an emulsion or a suspension is prepared by adding water, and if desired, the medium is removed.

(4) The aforesaid polyester resins are heat-fused and are subjected to contact dispersion with water or other media and thereafter, if desired, unnecessary media are removed.

(5) Minute particles of the aforesaid polyester resins, which have been prepared, are dispersed and stabilized in water or media comprised of water as a main component.

A production example of the polyester resin will now be described.

Initially, a hydrophilic polyester resin is dissolved in a hydrophilic organic solvent which exhibits a solubility of at least 20 g in one liter of water at 20° C. and a boiling point of at most 100° C., or which forms an azeotrope with water at less than or equal to 100° C. Exemplified as such organic solvents may be dioxane, acetone, tetrahydrofuran, and methyl ethyl ketone. It is possible to further add an appropriately small amount of surface active agents to such a solution.

Subsequently, while stirring, preferably under vigorous stirring while heating, water is added to the organic solvent solution in which the aforesaid polyester resins have been dissolved to prepare a water based composition. Alternatively, it is possible to prepare a water based composition employing a method in which, while stirring, the aforesaid organic solvent solution is dripped into water. The resulting water based composition is distilled under normal pressure, but preferably under reduced pressure to remove the hydrophilic solvents, whereby a water based composition of the hydrophilic polyester resin, comprising only water as media, is obtained. When the polyester resins are dissolved in hydrophilic organic solvents which form an azeotrope with water, during removal of the aforesaid organic solvent utilizing distillation, water is also removed as an azeotropic mixture. Therefore, it is preferable that an appropriately larger amount of water is previously added. After distillation, it is desired that the solid concentration is adjusted to at most 40 percent by weight. When the concentration exceeds 40 percent by weight, the polyester resins which have been dissolved or dispersed in water tend to result in re-coagulation, whereby stability of the water based composition is degraded. Moreover, it is preferable to adjust the solid concentration to at most 20 percent by weight. On the other hand, the lower limit of the solid concentration is not particularly limited. However, it is preferable to adjust it to at most 0.1 percent by weight. The average particle diameter of the aforesaid polyester resins is customarily at most 1 μm, and is preferably at most 0.8 μm.

The water based composition of polyester resins, prepared as above, is applied onto one or both sides of the polyester film described below and subsequently dried. By so doing, a primer layer is provided on the surface of the aforesaid film so that the resulting film exhibits good adhesion properties.

(Vinyl Modified Polyester)

Further, it is possible to preferably employ compounds which are prepared by modifying the hydrophilic polyester copolymers of the present invention, employing vinyl based monomers.

Modification, as described herein, means that vinyl based monomers undergo dispersion polymerization in an aqueous hydrophilic polyester copolymer solution. Dispersion is obtained in such a manner that, for example, hydrophilic polyester copolymers are dissolved in heated water, and vinyl based monomers are dispersed in the resulting aqueous hydrophilic polyester copolymer solution, whereby emulsion polymerization or suspension polymerization is carried out. It is preferable that polymerization is carried out employing an emulsion polymerization method.

Water based dispersion is described which is prepared in such a manner that vinyl based monomers undergo dispersion polymerization in the aqueous water-soluble polyester solution of the present invention.

Listed as water-soluble polyesters which are used to prepare the aforesaid water based dispersion are, for example, substantially linear polymers which are obtained employing a polymerization condensation reaction of polybasic acids, or ester forming derivatives thereof, with polyols or ester forming derivatives thereof.

Employed as polybasic acid components of the aforesaid water-soluble polyesters may be, for example, terephthalic acid, isophthalic acid, phthalic acid, 2,6-naphthalenedicarboxylic acid, 1,4-cyclohexanedicarboxylic acid, adipic acid, sebacic acid, trimellitic acid, pyromellitic acid, and dimeric acid. Further, along with these components, it is possible to employ a small proportion of unsaturated polybasic acids such as maleic acid, fumaric acid, and itaconic acid, and hydroxycarboxylic acids such as p-hydroxybenzoic acid, and p-(β-hydroxyethoxy)benzoic acid.

Further, employed as polyol components may be ethylene glycol, diethylene glycol, 1,4-butanediol, neopentyl glycol, dipropylene glycol, 1,6-hexanediol, 1,4-cyclohexanedimethanol, xylene glycol, trimethylolpropane, poly(ethylene oxide)glycol, and poly(tetramethylene oxide)glycol.

In the present invention, the aforesaid water-soluble polyesters preferably comprise terephthalic acid and isophthalic acid as the main dicarboxylic acid components. The mol ratio of terephthalic acid/isophthalic acid is most preferably 30/70 to 70/30 in terms of coatability onto polyester supports and solubility in water. The phthalic acid component and isophthalic acid component is preferably contained in an amount of 50 to 80 mol percent with respect to the total dicarboxylic acid components.

In order to make polyester water-soluble, an effective means is that components having a hydrophilic group such as a sulfonic acid salt containing component, a diethylene glycol component, a polyalkylene ether glycol component, and a polyether dicarboxylic acid component are introduced into polyester as copolymerization components. Preferably employed as components having a hydrophilic group are dicarboxylic acids having a sulfonic acid salt.

Specifically preferred as such dicarboxylic acids having a sulfonic acid salt are those having a sulfonic acid alkali metal salt group, which include alkali metal salts such as 4-sulfoisophthalic acid, 5-sulfoisopthalic acid, sulfophthalic acid, 4-sulfophthalic acid, 4-sulfonaphthalene-2,7-dicarboxylic acid and 5-(4-sulfophenoxy)isophthalic acid. Of these, sodium 5-sulfoisophthalate is specifically preferred. These sulfonic acid salt containing dicarboxylic acids are preferably employed in an amount ranging from 5 to 20 mol percent, and more preferably from 6 to 10 mol percent with respect to the total dicarboxylic acid components from the viewpoint of water-solubility and water resistance.

Further, in the water-soluble polyesters of the present invention in which terephthalic acid and isophthalic acid are used as major dicarboxylic components, it is preferable to employ aliphatic dicarboxylic acids as a copolymerization component. Listed as such aliphatic dicarboxylic acids may be, for example, 1,4-cyclohexanedicarbpxylic acid, 1,3-cyclohexanedicarboxylic acid, 1,2-cyclohexanedicarboxylic acid, 1,3-cyclopentanedicarboxylic acid, and 4,4′-bicyclohexyldicarboxylic acid.

Further, in the water-soluble polyester in which terephthalic acid and isophthalic acid are employed as main dicarboxylic components, other carboxylic acid(s) may be used as a copolymerization component. Listed as such dicarboxylic acids are, for example, aromatic dicarboxylic acids and straight-chain aliphatic dicarboxylic acids. The aromatic dicarboxylic acids are preferably used in an amount of at most 30 mol percent with respect to the total dicarboxylic acids components. Listed as such aromatic dicarboxylic acid components are, for example, phthalic acid, 2,5-dimethylterephthalic acid, 2,6-naphthalenedicarboxylic acid, 1,4-naphthalenedicarboxylic acid, and biphenyldicarboxylic acid. The straight-chain aliphatic dicarboxylic acids are used preferably in an amount of at most 15 mol percent. Listed as such straight-chain aliphatic dicarboxylic acid components are, for example, adipic acid, pimelic acid, suberic acid, azelaic acid, and sebacic acid.

Further, listed as glycol components of the water-soluble polyesters of the present invention are, for example, ethylene glycol, 1,4-butanediol, neopentyl glycol, 1,4-cyclohexanedimethanol, diethylene glycol, triethylene glycol, and polyethylene glycol.

When the water-soluble polyester of the present invention is prepared employing terephthalic acid and isophthalic acid as major dicarboxylic components, from the viewpoint of mechanical properties and adhesion properties with polyester supports, it is preferable to employ those comprising ethylene glycol or diethylene glycol in an amount of at least 40 mol percent with respect to the total glycols as glycol components of the water-soluble polyesters of the present invention.

The water-soluble polyester of the present invention can be synthesized employing dicarboxylic acids or ester forming derivatives thereof, and glycols or ester forming derivatives thereof as initial raw materials. Various methods can be employed for synthesis, and include, for example, a transesterification method or a direct esterification method, which are polyester production methods known in the art, in which an initial condensation product of dicarboxylic acid with glycol is formed and subsequently undergoes melt-polymerization. More specifically, there are a method in which, for example, dicarboxylic acid ester such as dimethyl ester of dicarboxylic acid and glycol undergo transesterification reaction and after removing methanol employing distillation, pressure is gradually reduced, whereby condensation polymerization is carried out under vacuum; a method in which dicarboxylic acid and glycol under go esterification reaction, and after removing the formed water employing distillation, pressure is gradually reduced, whereby polymerization condensation is carried out under high vacuum; and a method in which dicarboxylic acid ester and glycol undergo transesterification reaction, and further undergo esterification reaction by addition of dicarboxylic acid, and thereafter, polymerization condensation is carried out under high vacuum.

Employed as transesterification catalysts and polymerization condensation catalysts may be those known in the art. Employed as transesterification catalysts may be manganese acetate, calcium acetate, and zinc acetate, while employed as polymerization condensation catalysts may be antimony trioxide, germanium oxide, dibutyl tin oxide, and titanium tetrabutoxide. However, the various means such as polymerization methods and catalysts are not limited to the examples previously described.

In the present invention, a water based dispersion which is prepared in such a manner that vinyl based monomers undergo dispersion polymerization in an aqueous water-soluble polyester solution can be obtained as follows. For example, water-soluble polyester is dissolved in heated water, and vinyl based monomers are dispersed in the resulting aqueous water-soluble polyester solution. Subsequently, emulsion polymerization or suspension polymerization is carried out. Herein, polymerization is preferably carried out employing an emulsion polymerization.

In polymerization of vinyl based monomers, polymerization initiators are used. Listed as usable polymerization initiators are, for example, ammonium persulfate, potassium persulfate, sodium persulfate and benzoyl peroxide. Of these, ammonium persulfate is preferred.

It is possible to carry out polymerization without using surfactants. However, in order to enhance polymerization stability, it is possible to employ surfactants as emulsifiers. In such a case, it is possible to employ either common nonionic or anionic type surfactants.

Listed as vinyl based monomers acryl based monomers such as alkyl acrylates and alkyl methacrylates (an alkyl such as a methyl group, an ethyl group, an n-propyl group, an isopropyl group, an n-butyl group, an isobutyl group, a t-butyl group, a 2-ethylhexyl group, a cyclohexyl group, a benzyl group, and a phenylethyl group); hydroxy-containing monomers such as 2-hydroxyethyl acrylate, 2-hydroxyethyl methacrylate, 2-hydroxypropyl acrylate, and 2-hydroxypropyl methacrylate; amide-containing monomers such as acrylamide, methacrylamide, N-methylmethacrylamide, N-methylacrylamide, N-methylolacrylamide, N,N-dimethylolacrylamide, N-methoxymethylacrylamide, N-methoxy methylmethacrylamide, and N-phenylacrylamide; amino-containing monomers such as N,N-diethylaminoethyl acrylate, and N,N-diethylaminoethyl methacrylate; epoxy-containing monomers such as glycidyl acrylate and glycidyl methacrylate; and a carboxyl group or its salt-containing monomers such as acrylic acid, methacrylic acid and salts thereof (such as a sodium salt, a potassium salt, or an ammonium salt). Further, listed as monomers, other than acryl based monomers, are epoxy group-containing monomers such as allyl glycidyl ether; sulfonic acid group or its salt containing monomer such as styrenesulfonic acid, vinylsulfonic acid and salts thereof (such as a sodium salt, a potassium salt, or an ammonium salt); a carboxy group or its salt containing monomers such as crotonic acid, itaconic acid, maleic acid, fumaric acid and salts thereof (such as a sodium salt, a potassium salt, and an ammonium salt); acid anhydride containing monomers such as maleic anhydride and itaconic anhydride, vinyl isocyanate, allyl isocyanate, styrene, vinyl trisalkoxysilane, alkylmaleic acid monoester, alkylfumaric acid monoester, acrylonitrile; methacrylonitrile, alkylitaconic acid monoester, vinylidene chloride, vinyl acetate, and vinyl chloride.

The employed amount of vinyl based monomers is preferably at least 10 percent by weight in terms of the weight ratio of (polyester)/(vinyl based monomer), and is more preferably 10 to 50 percent by weight.

It is possible to form the sublayer of the present, for example, by applying a coating composition onto a support comprising an water based dispersion which is prepared by dispersion polymerizing vinyl based monomers in the aforesaid aqueous water-soluble polyester solution.

If desired, the sublayer of the present invention may be blended with polymers other than vinyl monomer modified polyester. Without particular limitations, employed as polymers are water-soluble polymers such as gelatin and polyvinyl alcohol and hydrophobic polymers such as vinyl based polymer latex, poly ethyl acrylate, vinylidene chloride, and polyurethane.

(Vinyl Based Polymer Latex)

Polymer latex, as described in the present invention, refers to polymer components in a dispersion in which the water-insoluble hydrophobic polymer is dispersed in water or a water-soluble dispersion medium in the form of minute particles. Dispersion states may be any of the following states: the polymer is emulsified in a dispersion medium in a dispersed state; the polymer is formed employing emulsion polymerization; the polymer is subjected to micelle dispersion; or the polymer has a partial hydrophilic structure in the molecule and the molecular chain itself is subjected to molecular dispersion.

Polymer latexes according to the present invention are described for example in “Gosei Jushi Emulsion (Synthetic Resin Emulsion)”, edited by Taira Okuda and Hiroshi Inagaki, published by Kobunshi Kankokai (1978); “Gosei Latex no Oyo (Application of Synthetic Latexes)”, edited by Takaaki Sugimura, Yasuo Kataoka, Soichi Suzuki, and Keiji Kasahara, published by Kobunshi Kankokai (1993); and Soichi Muroi, “Gosei Latex no Kagaku (Chemistry of Synthetic Latexes)”, published by Kobunshi Kankokai (1970).

The average diameter of dispersed particles in polymer latexes is preferably in the range of 1 to 50,000 nm, and is more preferably in the range of 5 to 1,000 nm. Dispersed particles may have either a wide particle size distribution or a particle size distribution showing monodispersion.

The vinyl based polymer latexes according to the present invention may include so-called core/shell type polymer latexes other than the common polymer latexes having a uniform structure. In such a case, it is occasionally preferable to regulate the glass transition temperature so that the glass transition temperature of the core is different from the shell.

The minimum film forming temperature (MFT) of the vinyl based polymer latexes according to the present invention is preferably −30 to 90° C., and is more preferably 0 to 70° C. Film forming aids may be added to control the minimum film forming temperature. Film forming aids, which are also called plasticizers, are organic compounds (customarily organic solvents capable of lowering the minimum film forming temperature of the latexes), which are described, for example, in Soichi Muroi, “Gosei Latex no Kagaku (Chemistry of Synthetic Latexes)”, published by Kobunshi Kankokai (1970), which has previously been cited.

The used amount of vinyl based monomers is preferably in the range of 99/1 to 5/99 in terms of ratio by weight of (hydrophilic polymer)/(vinyl based monomers constituting vinyl based polymer latex).

Vinyl based polymer latexes usable in the present invention can be prepared employing any of the several emulsion polymerization methods. For example, using water as a dispersing medium, with 10 to 50 percent by weight of monomers with respect to water, 0.05 to 5 percent by weight of polymerization initiators with respect to monomers and 0.1 to 20 percent by weight of dispersing agents with respect to monomers, polymerization is carried out at a temperature of 30 to 100° C. (and preferably 60 to 90° C.) for a period of 3 to 8 hrs., while stirring. In the preparation, conditions such as amounts of monomers and polymerization initiators, reaction temperature and reaction time can be varied.

Employed as polymerization initiators may be water-soluble peroxides (for example, potassium persulfate and ammonium persulfate), water-soluble azo compounds (for example, 2,2′-azobis(2-aminodipropane) hydrochloride), and their combination along with reducing agents such as Fe²⁺ salts or sodium hydrogen sulfite, i.e., redox type polymerization initiators. Employed as dispersing agents are water-soluble polymers. Further, it is possible to use any of the several anionic surfactants, nonionic surfactants, cationic surfactants and amphoteric surfactants.

The number average particle diameter of the vinyl based polymer latexes is preferably 0.005 to 2.0 μm, and is more preferably 0.01 to 0.8 μm.

As the vinyl based latexes, acryl based polymer latexes are preferred. Acryl based latexes, as described herein, refer to polymer latexes which comprise acryl based monomers such as methacrylic acid and acrylic acid, and esters or salts thereof, acrylamide or methacrylamide in an amount of at least 50 mol percent with respect to the total polymer components.

The acryl based polymer latexes may be produced employing individual acryl based monomers or acryl based monomers together with other monomers (hereinafter referred to as co-monomers) which are copolymerizable with the acryl based monomers. Listed as acryl based monomers are, for example, acrylic acid; methacrylic acid; acrylic acid esters such as alkyl acrylate (for example, methyl acrylate, ethyl acrylate, n-propyl acrylate, isopropyl acrylate, n-butyl acrylate, isobutyl acrylate, t-butyl acrylate, 2-ethylhexyl acrylate, cyclohexyl acrylate, phenyl acrylate, benzyl acrylate, and phenylethyl acrylate); hydroxy-containing alkyl acrylate (for example, 2-hydroxyethylacrylate, 2-hydroxypropyl acrylate); methacrylic acid esters such as alkyl methacrylate (for example, methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclohexyl methacrylate, phenyl methacrylate, benzyl methacrylate, and phenylethyl methacrylate); hydroxy-containing alkyl methacrylate (for example, 2-hydroxyethyl methacrylate, 2-hydroxypropyl methacrylate); acrylamide; substituted acrylamide such as N-methylacrylamide, N-methoxymethyl acrylamide; methacrylamide; substituted methacrylamide such as N-methylmethacylamide, N-methylol methacylamide, N,N-dimethylol methacrylamide, and n-methoxymethyl methacrylamide; amino-substituted alkyl methacrylate such as N,N-diethylaminomethacrylate; epoxy group-containing acrylate such as glycidyl acrylate; epoxy group-containing methacrylate such as glycidyl methacrylate; and acrylate salts such as sodium salt and potassium salt and ammonium salt. The aforesaid monomers may be employed individually or in combination of at least two types.

Listed as co-monomers are styrene and derivatives thereof; unsaturated carboxylic acids (for example, itaconic acid, maleic acid, and fumaric acid); unsaturated carboxylic acid esters (for example, methyl itaconate, dimethyl itaconate, methyl maleate, dimethyl maleate, methyl fumarate, and dimethyl fumarate); unsaturated dicarboxylate salts (for example, sodium salt, potassium salt, and ammonium salt); sulfonic acid or its salt-containing monomers comprising a sulfonic acid or salts thereof (for example, styrenesulfonic acid, vinylsulfonic acid, and salts thereof (for example, sodium salt, potassium salt, and ammonium salt); acid anhydrides such as maleic anhydride and itaconic anhydride; vinyl isocyanates; allyl isocyanates; vinyl methyl ethers; vinyl ethyl ethers; and vinyl acetates. The aforesaid monomers may be employed individually or in combination of at least two types.

(Styrene-Diolefin Based Polymers)

1) Sublayer Comprising Hydrophobic Polymers Comprised of Styrene-Diolefin Copolymers

Preferred as the styrene-diolefin based copolymers of the present invention are diolefin based rubber materials. The diolefin monomers refer to monomers having two double bonds in one molecule and may be aliphatic unsaturated hydrocarbons or may have a ring structure.

Specifically listed may be conjugated dienes such as butadiene, isoprene, and chloroprene, and non-conjugated dienes such as 1,4-pentadiene, 1,4-hexadiene, 3-vinyl-1,5-hexadiene, 1,5-hexadinene, 3-methyl-1,5-hexadiene, 3,4-dimethyl-1,5-hexadiene, 1,2-divinylcyclobutane, 1,6-heptadiene, 3,5-diethyl-1,5-heptdiene, 4-cyclohexyl-1,6-heptadiene, 3-(4-pentenyl)-1-cyclopentane, 1,7-octadiene, 1,8-nanodiene, 1,9-decadiene, 1,9-octadecadiene, 1-cis-9-cis-1,2-octadecatrine, 1,10-undecadiene, 1,11-dodecadiene, 1,12-tridecadinene, 1,13-tetradecadiene, 1,14-pentadecadiene, 1,15-hexadecadiene, 1,17-octadecadiene, and 1,21-docosadiene.

Of these diolefin monomers, butadiene, isoprene, and chloroprene, which are conjugated dienes are preferably employed, but butadiene is most preferably employed.

Styrene, which is the other monomer forming copolymers, refers to styrene and derivatives thereof. Listed as styrene derivatives may be, for example, methyl styrene, dimethylstyrene, ethylstyrene, diethylstyrene, isopropylstyrene, butylstyrene, hexylstyrene, cyclohexylstyrene, decylstyrene, pentylstyrene, chloromethylstyrene, trifluoromethylstyrene, ethoxymethylstyrene, acetoxymethylstyrene, methoxystyrene, 4-methoxy-3-methylstyrene, dimethoxystyrene, chlorostyrene, dichlorostyrne, trichlorostyrene, tetrachlorosyrene, pentachlorostyrene, bromostyrene, dibromostyrene, iodostyrene, fluorostyrene, trifluorostyrene, 2-bromo-4-trifluoromethylstyrene, 4-fluoro-3-trifluoromethylstyrene, vinylbenzoic acid, vinylbenzoic acid methyl ester, divinylbenzene, and 1,5-hexadiene-3-in, and hexatriene.

The proportion of diolefin monomers in the copolymers of the present invention is preferably 10 to 60 percent by weight with respect to the total copolymers, and is more preferably 15 to 40 percent by weight. The proportion of styrenes is preferably 40 to 70 percent by weight with respect to the total copolymers. Further, monomers as a third component may be incorporated in the copolymers employed in the present invention. Listed as preferable third components are acrylic acid esters, methacrylic acid esters, vinyl esters, and chlorine containing monomers such as vinyl chloride. Further, it is possible to copolymerize monomers such as acroyl, having a methacroyl group and an allyl group.

Listed as those may be divinyl ether, divinylsulfone, diallyl phthalate, diallylcarbinol, diethylene glycol dimethacrylate, trimethylolpropane trimethacrylate, and trimethylolpropane dimethacrylate.

After polymerization, the resulting polymer becomes insoluble in any solvent, since a diene based monomer which is one of components is gelled due to its self-crosslinking.

Listed as polymerization methods to prepare such polymers are, for example, an emulsion polymerization method, a solution polymerization method, a bulk polymerization method, a suspension polymerization method, and a radiation polymerization. It is preferable that polymers in the form of latex are formed employing emulsion polymerization. Further, when crosslinkable monomers are employed, the gel fraction ratio of the latex is preferably 50 to 95 percent by weight. Gel, as described herein, refers to the state in which copolymers having the composition as specified in the present invention are three-dimensionally polymerized. When the copolymers having the composition as specified in the present invention are three-dimensionally polymerized, solubility in solvents varies depending on the degree of three-dimensional polymerization. Namely, as the degree of three-dimensional polymerization increases, the resulting polymers become less soluble. Accordingly, the degree of the three-dimensional polymerization of the gel is determined depending on the resulting solubility. Of course, solubility varies depending on employed solvents. As a result, the definition of the degree of three-dimensional polymerization of the gel differs depending on each solvent. However, in the present invention, gel, as described herein, refers to the state in which copolymerization is carried out three-dimensionally and which is not dissolved in purified tetrahydrofuran over 48 hours at 20° C.

Regarding the solution polymerization, polymers are obtained by polymerizing in solvents a monomer mixture having a suitable concentration (customarily at most 40 percent by weight with respect to the solvents, and preferably from 10 to 25 percent by weight) in the presence of initiators at 30 to 120° C. for 0.5 to 48 hours.

Employed as solvents may be any of those which dissolve a monomer mixture. Listed as those examples may be water, methanol, ethanol, dimethylsulfoxide, dimethylformamide, and dioxane, and mixed solvents consisting of at least two of these.

Employed as initiators may be those which are soluble in polymerization solvents. Listed as examples may be organic solvent based initiators such as benzoyl peroxide, azobisisobutyronitrile (AIBN) and di(t)butyl peroxide, water-soluble initiators such as ammonium persulfate (APS), potassium persulfate, and 2,2′-azobis-(2-aminopopane)hydrochloride, and redox based polymerization initiators comprising reducing agents such as Fe²⁺ salts or sodium hydrogen sulfite, along with the aforesaid compounds.

In the emulsion polymerization, water is used as a dispersion medium. Polymers are obtained by polymerizing while stirring monomers, in an amount of 10 to 50 percent by weight with respect to water, polymerization initiators in an amount of 0.05 to 5 percent by weight with respect to the monomers, and dispersing agents in an amount of 0.1 to 20 percent by weight with respect to the monomers at 30 to 100° C. or preferably at 60 to 90° C. for 3 to 8 hours. It is possible to broadly and easily change the monomer concentration, the initiator amount, the reaction temperature, and the time.

Employed as dispersion agents are water-soluble polymers which include anionic surfactants, nonionic surfactants, cationic surfactants, and amphoteric surfactants.

The copolymers of the present invention may be obtained employing prior art synthetic methods which are-employed to obtain common diolefin-containing latexes. Specifically, it is more preferable to carry out emulsion polymerization in a water dispersion system, than homogeneous polymerization in organic solvents, which necessitates post treatments. During polymerization, employed as polymerization initiators may be organic or inorganic peroxides, acetyl hydroperoxide, hydrogen peroxide, and per-salts such as percarbonates, persulfates, and perborates. In order to enhance the performance of initiators, commonly employed organic or inorganic reducing agents may be used in combination. During polymerization or after polymerization, in order to enhance dispersion stability, various types of dispersion aids may be used. Employed as dispersion aids may be polymer protective colloids such as polyvinyl alcohol and hydroxymethyl cellulose, as well as anionic or nonionic surfactants such as sodium dodecylbenznesulfonate, sodium laureate, polyoxyethylene aliphatic acid monoesters, and polyoxyethylene pentyl ethers. If desired, mercaptans, being molecular weight regulating agents, may also be added.

Polymerization is carried out in a tightly sealed vessel, and should optimally be carried out depending on the addition method of each component to the polymerization system, the addition concentration, the temperature and pressure during polymerization, and the stirring conditions. Diolefin monomers may be added in a calculated amount or in an excessive amount, and after reaction, the residual monomers may be recovered.

If desired, stabilizers having a glycidyl group, reaction accelerators, and crosslinking agents may be added prior to or during synthesis. In order to provide higher standing stability to the latex after synthesis, as commonly employed methods, added may be pH regulators, surfactants, dispersion stabilizers, and wetting agents. The average particle diameter of hydrophobic polymers is most preferably 0.01 to 0.8 μm, while those having a diameter of 0.005 to 2.0 μm may be preferably employed.

When polymerized in organic solvents, the hydrophobic polymers may be further dispersed in water and employed in such a manner that solvents are replaced with water under reduced pressure.

It is preferable that hydrophobic polymers employed in a sublayer are modified into a water based dispersion (being a latex), to which, if desired, crosslinking agents, surfactants, swelling agents, matting agents, and antistatic agents are added. Cross-linking agents include, for example, triazine based compounds described in U.S. Pat. Nos. 3,325,287, 3,288,775, and 3,549,377, and Belgium Patent No. 6,602,226; dialdehyde based compounds described in U.S. Pat. Nos. 3,291,624 and 3,232,764, French Patent No. 1,543,691, and British Patent No. 1,270,578; epoxy based compounds described in U.S. Pat. No. 3,091,537 and Japanese Patent Publication No. 49-26580; vinyl based compounds described in U.S. Pat. No. 3,642,486; aziridine based compounds described in U.S. Pat. No. 3,392,024; and ethyleneimine based compounds and methylol based compounds described in U.S. Pat. No. 3,549,378. Of these compounds, dichlorotriazine derivatives are preferred. In the present invention, so-called hardeners for photographic gelatin, described below, are preferably employed.

Listed as copolymers preferably used in the present invention may be, for example, styrene-butadiene, styrene-isoprene, styrene-chloroprene, methyl methacrylate-butadiene, and acrylonitrile-butadiene. Of these, styrene-butadiene based latexes are particularly preferred. Further, it is acceptable to use commercially available copolymers.

(Polyvinyl Alcohol (PVA))

Listed as polymers comprising polyvinyl alcohol units may be polyvinyl alcohols derivatives such as ethylene copolymerization polyvinyl alcohol and polyvinyl alcohol modified materials which are prepared by dissolving partially butylated polyvinyl alcohol in water.

The degree of polymerization of polyvinyl alcohol is preferably at least 100. Further, listed as copolymerization components of vinyl acetate based polymers prior to saponification of polymers having vinyl alcohol units may be polymers having monomer units, such as vinyl compounds, such as ethylene and propylene; acrylic acid esters (such as t-butyl acrylate, phenyl acrylate, and 2-naphthyl acrylate); methacrylic acid esters (such as methyl methacrylate, ethyl methacrylate, 2-hydroxyethyl methacrylate, benzyl methacrylate, 2-hydroxypropyl methacrylate, phenyl methacrylate, cyclohexyl methacrylate, cresyl methacrylate, 4-chlorobenzyl methacrylate, and ethylene glycol dimethacrylate); acrylamides (such as acrylamide, methylacrylamide, ethylacrylamide, propylacrylamide, butylacrylamide, tert-butylacrylamide, cyclohexylacrylamide, benzylacrylamide, hydroxymethylacrylamide, methoxyethylacrylamide, dimethylaminoethylacrylamide, phenylacrylamide, dimethylacrylamide, diethylacrylamide, β-cyanoethylacrylamide, and diacetoneacryl amide); methacrylamides (such as methacrylamide, methylmethacrylamide, ethylmethacrylamide, propylmethacrylamide, butylmethacrylamide, tert-butylmethacrylamide, cyclohexylmethacrylamide, benzylmethacrylamide, hydroxymethylmethacrylamide, methoxyethylmethacrylamide, dimethylaminoethylmethacrylamide, phenylmethacrylamide, dimethylmethacrylamide, diethylmethacrylamide, and β-cyanoethylmethacrylamide); styrenes (such as styrene, methylstyrene, dimethylstyrene, trimethylenestyrene, ethylstyrene, isopropylstyrene, chlorostyrene, methoxystyrene, acetoxystyrene, chlorostyrene, dichlorostyrene, bromostyrene, and vinylbenzoic acid methyl ester); divinylbenzene, acrylonitrile, methacrylonitrile, N-vinylpyrrolidone, N-vinyloxazolidone, vinylidene chloride, and phenyl vinyl ketone. Of these, ethylene copolymerization polyvinyl alcohol is preferred.

Commercially available polyvinyl alcohols and modified polyvinyl alcohols may generally be employed. Listed as representative commercially available polyvinyl alcohols are PVA-203, PVA-204, PVA-205, PVA-210, PVA-217, PVA-220, PVA-224, PVA-228, PVA-235, PVA-403, PVA-405, and PVA-420, manufactured by Kuraray Co., Gosenol GL-03, GL-05, AL-O₂, and NK-05, manufactured by Nihon Gosei Kagaku Co., and Denka Poval K-02 and B03, manufactured by Denki Kagaku Kogyo Co. Listed as representative commercially available modified polyvinyl alcohols are MP-202 and MP-203, manufactured by Kuraray Co.

(Polyurethane)

Urethane employed in the present invention is preferably water-soluble or water-dispersible polyurethane. It is possible to use polyurethane based resins described in Japanese Patent Publication Nos. 42-24194, 46-7720, 46-10193, 49-37839, 46-10193, and 49-37839, and Japanese Patent Publication Open to Public Inspection Nos. 50123197, 53-126058, and 54-138098, as well as polyurethane based resins in accordance with those described above.

Main polyurethane constituting components are polyisocyanates, polyols, chain length expanding agents and crosslinking agents. Examples of polyisocyanates include trilenediisocyanate, phenylenediisocyanate, 4,4′-diphenylmethanediisocyante, hexamethylenediisocyanate, xylenediisocyanate, 4,4′-dicyclohexylmethanediisocyanate, and isoholondiisocyanate. Examples of polyols include polyethers such as polyoxyethylene glycol, polyoxypropylene glycol, polyoxytetramethylene glycol; polyesters such as polyethylene adipate, polyethylene butylenes adipate, and others such as polycaprolactone, acryl based polyols, and castor oil.

Examples of chain-length expanding agents as well as crosslinking agents include ethylene glycol, propylene glycol, diethylene glycol, trimethylolpropane, hydrazine, ethylenediamine, diethylenetriamine, 4,4′-diaminodiphenylmethane, 4,4′-diaminodicyclohexylmethane, and water. In order to achieve water solubility or water dispensability, forced dispersion may be carried out employing surfactants. However, hydrophilic nonionic components such as polyethers and self-dispersion type coating agents, such as polyethers, are preferably employed. Furthermore, water-soluble or water-dispersible polyurethane based resin coating agents are more preferably employed.

It is possible to produce polyurethane based resins having an anionic group, employing a method in which polyols, polyisocyanate compounds and compounds such as chain-length expanding agents having an anionic group are employed, a method in which unreacted isocyanate groups of formed polyurethane are allowed to react with compounds having an anionic group, or a method in which active hydrogen containing groups of polyurethane are allowed to react with the specified compounds. When compounds having an anionic group are employed as a polyurethane forming component, it is possible to employ, for example, compounds which are obtained employing a method in which the aromatic isocyanate compounds are sulfonates, diaminocarboxylic acid salts, and sulfuric acid ester salts of aminoalcohols.

In a method in which non-reacted isocyanate groups of polyurethane are allowed to react with compounds having an anionic group, it is possible to employ, for example, bisulfite salts, aminosulfonic acid and salts thereof, aminocarboxylic acid and salts thereof, sulfuric acid esters of aminoalcohols and salts thereof, as well as hydroxyacetic acid and salts thereof. In a method in which active hydrogen containing groups of polyurethane are allowed to react with the specified compounds, cyclic compounds are employed such as dicarboxylic acid anhydrides, tetracarboxylic acid anhydrides, sultone, lactone, epoxycarboxylic acid, epoxysulfonic acid, 2,4-dioxo-oxazolidione, isatoic acid anhydride, hostone, and carbinic acid sulfate.

Polyurethane resins employed in the present invention are preferably comprised of polyols having a molecular weight of 300 to 20,000, polyisocyanates, chain-length increasing agents, and compounds having of a group which reacts with an isocyanate group and at least one anionic group. The anionic group in the polyurethane based resins is employed as lithium salt, sodium salt, potassium salt or magnesium salt of —SO₃H, —OSO₃H, and —COOH. Of these, a sulfonic acid salt group as well as a carboxylic acid salt group is particularly preferred. The proportion of the anionic group in the polyurethane based resins is preferably in the range of 0.05 to 8 percent by weight. When the proportion of the anionic group is too small, water solubility as well as water dispersibility is degraded, while when the proportion is too large, water resistance of the coating layer after coating is degraded or films tend to adhere to each other due to moisture absorption.

Listed as examples of commercially available hydrophilic polyurethanes may be Takelux XW Series W-7004, W-6015, W-621, W-511, W-310, and W-512, manufactured by Takeda Yakuhin Kogyo Co.; Impranil DHL and Impranil DLN, manufactured by Bayer Co.; Superflex 100, Superflex 200, Superflex 300, Haidoran HW-140, Haidoran HW-111, Haidoran HW-100, Haidoran HW-101, Haidoran HW-312, Haidoran HW-311, Haidoran HW-310, Haidoran LW-513, Haidoran HC-200, Haidoran HC-400M, Bondic lOlOC, Bondic 1050, Bondic 1070, Bondic 1310B, Bondic 1310F, Bondic 1310NS, Bondic 1340, Bondic 1510, Bondic 1610NS, Bondic 1630, Bondic 1640, Bondic 1670(N), and Bondic 1670-40, manufactured by Dai-Ichi Kogyo Seiyaku Co. Of these commercially available hydrophilic polyurethanes, listed as particularly preferable products may be W-7004, W-6015, Impranil DLH, Impranil DLN, Superflex 100, Superflex 200, Haidoran HW-140, Haidoran HW-310, and Haidoran HW-311. (Inorganic Fillers) Listed as inorganic fillers which may be added to the sublayer according to the present invention are, for example, oxides, hydroxides, carbonates, sulfates, silicates, nitrides, carbons, various metals, and alloys, described in “Filler Katsuyo Jiten (Filler Application Handbook)”, by Filler Kenkyu Kai, First Edition, First Printing.

Specifically listed are inorganic fillers such as carbon black, graphite, carbon fibers, carbon barun, various metals, calcium hydroxide, magnesium hydroxide, aluminum hydroxide, TiO₂, BaSO₄, calcium sulfate, satin spar, ZnS, MgCO₃, CaCO₃, zinc carbonate, barium carbonate, dosonite, hydrotalsite, ZnO, CaO, WS₂, MOS₂, MgO, SnO₂, Al₂O₃, α-Fe₂O₃, α-FeCOOH, SiC, CeO₂, BN, SiN, MoC, BC, WC, titanium carbide, corundum, artificial diamond, garnet, silica, toriboli, diatomaceous earth, dolomite, calcium silicate (worastnite and sonotorite), talc, clay, mica, montnorillonite, bentonite, activated clay, cepiorite, imogorite, ceisarite, glass fibers, glass beads, silica based barun, aluminum nitride, boron nitride, and silicon nitride, and colloidal silica.

The particle shape is not particularly specified and fiber, needle, tabular, and granular particles are employed. Further, the particle diameter is preferably about 0.005 to about 10 μm in terms of an equivalent sphere.

Further, these inorganic fillers may be employed in combination of several types or along with organic fillers such as polyethylene resin particles, fluorine resin particles, guanamine resin particles, acrylic resin particles, silicone resin particles, and melamine resin particles.

(Others)

It is possible to add surfactants such as anionic surfactants, cationic surfactants, and nonionic surfactants to the aforesaid sublayer forming coating composition in a necessary amount.

Preferred as such surfactants are those capable of adjusting the surface tension of a water based coating composition to at most 500 μN/cm² and of enhancing wettability of polyester film. Examples include polyoxyethylene alkylpenyl ethers, polyoxyethylene-aliphatic acid esters, sorbitan fatty acid esters, glycerin fatty acid esters, fatty acid metal soaps, alkyl sulfates, alkyl sulfonates, alkyl sulfosuccinates, quaternary ammonium chlorides, and alkylamine hydrochlorides.

If desired, plasticizers, crosslinking agents, and dyes may be incorporated in the sublayer according to the present invention.

If desired, swelling agents, matting agents, cross-over dyes, antihalation dyes, pigments, antifoggants, and antiseptics may be incorporated in the sublayer coating composition according to the present invention. Employed as swelling agents are, for example, phenol, resorcinol, cresol, and chlorophenol. The added amount may be 1 to 10 g per liter of the sublayer coating composition of the present invention. Preferred as matting agents are silica having a particle diameter of 0.1 to 10 μm, polystyrene spheres, and methyl methacrylate spheres.

In the present invention, it is preferable that matting agents are incorporated in the sublayer to improve high speed conveyance properties. Employed as matting agents are minute particles having an average diameter of 0.1 to 8 μm, and preferably about 0.2 to about 5 μm, comprised of styrene, polymethyl acrylate, and silica. The used amount of matting agents is preferably 1 to 200 mg per m2 of heat-developing recording materials, and is more preferably 2 to 100 mg.

The dried layer thickness of the sublayer according to the present invention is preferably 0.01 to 10 μm, and is more preferably from 0.03 to 3 μm.

Further, it is possible to add other additives such as antistatic agents, UV absorbers, pigments, organic fillers, inorganic fillers, lubricants, blocking minimizing agents, and stabilizers to the primer layer forming coating compositions.

Employed as crosslinking agents are compounds, known in the art, such as epoxy, isocyanates, and melamine. Further, active halogen crosslinking agents are preferred which are described in Japanese Patent Application Open to Public Inspection No. 51-114120.

Employed as dyes may be antihalation dyes and tone controlling dyes.

The sublayer of the present invention may be formed by coating either a water based or an organic solvent based coating composition, and subsequently drying the resulting coating. However, from the viewpoint of cost and environmental protection, more preferred is the water based coating in which the water based coating composition is coated. “Water based coating composition”, as described herein, refers to a coating composition in which the proportion of water in the coating composition is at least 30 percent by weight of the solvents (dispersion medium) of the entire coating composition, and is preferably at least 50 percent by weight. Listed as specific solvent compositions other than water are solvent mixtures described below:

Water/methanol=85/15, water/methanol=70/30, water/methanol/dimethylformamide (DFF)=80/15/5, water/isopropyl alcohol=60/40 (wherein numerals show a weight ratio)

Only one sublayer comprising a polyester of the present invention may be provided or at least two sublayers comprising the same may be provided.

In the heat-developing recording material of the present invention, a sublayer comprising no polyester may be provided in addition to the aforesaid sublayer comprising the polyester. Employed as binders used in such sublayers may be, for example, gelatin. If desired, the aforesaid crosslinking agents, matting agents, dyes, fillers, and surfactants may be added to such sublayers. The thickness of such sublayers is preferably 0.02 to 30 μm per layer, and is more preferably 0.08 to 30 μm.

It is possible to form a sublayer according to the present invention while coating employing any of the several well known methods and subsequently drying it. Listed as usable coating methods are, for example, a dip coating method, an air knife coating method, a curtain coating method, a roller coating method, a wire bar coating method, and a gravure coating method, and an extrusion coating method employing a hopper, described in U.S. Pat. No. 2,681,294. Further, if desired, it is possible to preferably use a method in which at least two layers are simultaneously coated, described in U.S. Pat. Nos. 2,761,791, 3,508,947, 2,941,893, and 3,526,528 and Yuji Harazaki, “Coating Engineering” page 253 (1973, published by Asakura Shoten).

The coating thickness of the coating composition employed for the sublayer according to the present invention is preferably 3 to 100 μm, and is more preferably 5 to 20 μm. Drying conditions after coating the coating composition employed for the sublayer of the present invention are 25 to 200° C. for about 0.5 second to about one minute. It is preferable that the sublayer of the present invention is subjected to a thermal treatment after coating and drying. Such treatment conditions range from 110 to 200° C. for about 10 seconds to about 10 minutes.

The optimal temperature of coating compositions is 25 to 35° C. When the temperature exceeds 35° C., the pot life of the coating composition degrades, while when the temperature is less than 25° C., adhesion strength as well as film forming strength occasionally degrades.

(Backing Layer)

In the heat-developing light-sensitive photographic material according the present invention, a solvent based or water based backing layer may be formed on the side opposite the image forming layer.

It is possible to coat the backing layer employing either a solvent based coating composition or a water based coating composition. Only one backing layer may be provided or at least two backing layers may also be provided.

The solvent based backing layer, as described in the present invention, refers to one which is formed by coating the solvent based coating composition. On the other hand, the water based backing layer, as described herein, refers to one which is formed by coating the water-based coating composition. The solvent based, as described herein, means that the proportion of organic solvents is at least 50 percent by weight of the total solvents, while water based, as described herein, means that the proportion of organic solvents is less than 50 percent by weight of the total solvents.

Employed as suitable binders for the backing layer according to the present invention are commonly colorless natural or synthetic polymers which may be transparent or translucent. Examples include gelatin, gum Arabic, polyvinyl alcohol, hydroxyethyl cellulose, cellulose diacetate, cellulose acetate butyrate, polyvinylpyrrolidone, casein, starch, polyacrylic acid, polymethyl methacrylic acid, polyvinyl chloride, polymethacrylic acid, styrene-maleic anhydride copolymers, styrene-acrylonitrile copolymers, styrene-butadiene copolymers, polyvinyl acetals (for example, polyvinyl formal and polyvinyl butyral), polyesters, polyurethanes, phenoxy resins, polyvinylidene chloride, polyepoxides, polycarbonates, polyvinyl acetate, and polyamides.

Preferably employed as a binder of the solvent based backing layer is, for example, cellulose acetate butyrate, while preferably employed as binders of the water based backing layer are, for example, polyvinyl alcohol and gelatin.

In the present invention, the maximum absorption of the backing layer in the desired wavelength region is preferably 0.3 to 2 in terms of optical density and is more preferably 0.5 to 2. In addition, absorption in the visible region after processing is preferably 0.01 to 0.5 in terms of optical density, and is more preferably 0.001 to 0.3.

If desired, surfactants, crosslinking agents, and slipping agents may further be incorporated in the backing layer according to the present invention. Further, it is possible to provide a backing resistive heating layer as described in U.S. Pat. Nos. 4,460,681 and 4,374,921.

The thickness of the backing layer according to the present invention is preferably 0.1 to 20 μm, and is more preferably 0.5 to 10 μm.

In the heat-developing light-sensitive photographic material of the present invention, a protective layer (being a backing layer surface protective layer) may be provided on the aforesaid backing layer. Binders of the backing layer surface protective layer are not particularly limited, and it is possible to employ polymers similar to those described in the backing layer according to the present invention. It is preferable that the backing layer surface protective layer according to the present invention is formed by coating the aforesaid water based coating composition which is then dried. If desired, matting agents, dyes, slippage agents, and surfactants may be added to the backing layer surface protective layer of the present invention.

The thickness of the backing layer surface protective layer is preferably 0.1 to 10 μm, and is more preferably 0.5 to 5 μm.

(Organic Silver Salts)

Organic silver salts (hereinafter referred to as organic silver salts according to the present invention) usable in the silver salt photothermographic dry imaging material of the present invention are reducible silver sources, and are preferably organic acid or heterorganic acid silver salts, especially long chain (having from 10 to 30 carbon atoms, and preferably from 15 to 25 carbon atoms) aliphatic carboxylic acid and nitrogen containing heterocyclic compounds.

Organic or inorganic complexes are also preferred which are described in Research Disclosure Items 17029 and 29963 so that ligands have an overall stability constant of 4.0 to 10.0 with respect to silver ions. Listed as appropriate examples of such silver salts are silver salts of organic acids such as gallic acid, oxalic acid, behenic acid, stearic acid, arachidic acid, palmitic acid, and lauric acid. Listed as other examples are organic silver salts described in paragraph No. ┌0193┘ of Japanese Patent Application Open to Public Inspection No. 2001-83659. Further, with regard to the preparation method of the silver salts as well as the particle diameter of organic silver salt particles, it is also possible to refer to paragraph Nos. ┌0194┘ through ┌0197┘ of the aforesaid patent. Still further, techniques described in paragraph Nos. ┌0028┘ through ┌0033┘ of Japanese Patent Application Open to Public Inspection No. 2001-48902 and paragraph Nos. ┌0025┘ through ┌0041┘ of Japanese Patent Application Open to Public Inspection No. 2000-72777 may be applied to the organic silver salts according to the present invention.

(Light-Sensitive Layers)

Light-sensitive silver halide (hereinafter referred to as light-sensitive silver halide according to the present invention) which is usable in the silver salt photothermographic dry imaging material of the present invention as described herein, refer to silver halide crystalline grains which can originally absorb light as an inherent quality of silver halide crystals, and can absorb visible light or infrared radiation through artificial physicochemical methods and are treatment-produced so that physicochemical changes occur in the interior of the silver halide crystal and/or on the crystal surface, when the crystals absorb any radiation in the wavelength ranging from ultraviolet to infrared radiation.

The light-sensitive silver halide according to the present invention can be prepared in the form of a silver halide grain emulsion, employing methods described in P. Glafkides, “Chimie et Physique Photographique”, (published by Paul Montel Co., 1967), G. F. Duffin, “Photographic Emulsion Chemistry”, (published by The Focal Press, 1955), and V.L. Zelikman et al., “Making and Coating Photographic Emulsion”, published by The Focal Press, 1964).

Of these, a so-called double jet method is preferred in which silver halide grains are formed while controlling grain forming conditions. Halogen compositions are not particularly limited, and any of silver chloride, silver chlorobromide, silver chloroiodobromide, silver bromide, silver iodobromide, and silver iodide may be employed. Further, the silver halide grain formation according to the present is commonly divided into two processes, i.e., formation of silver halide seed grains (nuclei) and grain growth. Methods may be employed in which these processes may continuously be carried out at one time, or nuclei (seed grains) formation and grain growth are separately carried out. Further, it is possible to employ a technique described in paragraph No. ┌0063┘ of Japanese Patent Application Open to Public Inspection No. 2001-83659.

In order to control milkiness after image formation to a lower level as well as to obtain excellent image quality, it is preferable that the average grain size of the light-sensitive silver halide according to the present invention is reduced. The average grain size is preferably at most 0.2 μm, is more preferably 0.01 to 0.17 μm, and is most preferably 0.02 to 0.14 μm. Grain size, as described herein, refers to the edge length when silver halide grains are in the form of a so-called normal crystal, such as cubic or octahedral crystals. Further, when silver halide grains are tabular, the aforesaid grain size refers to the diameter of the circle which has the same area as the projection area of the main surface of the grain.

The resulting grains are preferably monodispersed. In order to prepare such monodispersed grains, it is possible to use a technique described in paragraph Nos. ┌0064┘ through ┌0066┘ of Japanese Patent Application Open to Public Inspection No. 2001-83659. It is possible to employ any silver halide grains which are cubic, octahedral, tetradecahedral or tabular. In the case of tabular silver halide grains, the average aspect ratio is customarily 1.5 to 100, and is preferably 2 to 50. In order to obtain such an aspect ratio, it is possible to use techniques described in U.S. Pat. Nos. 5,264,337, 5,314,789, and 5,320,958. Further, employed as grain forming technique may be ant of the ones described in paragraph Nos. ┌0068┘ through ┌0090┘ of Japanese Patent Application Open to Public Inspection No. 2001-83659.

In order to minimize reciprocity failure due to intensity, it is preferable that the light-sensitive silver halide according to the present invention comprises ions of transition metals in Groups 6 through 11 of the Periodic Table. The content ratio is preferably in the range of 1×10⁻⁹ to 1×10⁻² mol per mol of silver, and is more preferably in the range of 1×10⁻⁸ to 1×10⁻⁴ mol. Preferred transition metal complexes or complex ions are represented by General Formula (ML₆)ₘ (wherein M represents a transition metal selected from elements in Groups 6 through 11 of the Periodic Table, L represents a ligand, and m represents 0, -, 2-, 3- or 4-.). Listed as specific examples of the ligand represented by L are halogen ions (fluorine ions and chlorine ions), ligands of cyanide, cyanato, thiocyanato, selenocyanato, tellurocyanato, azido, and aqua, as well as nitrosyl and thionitrosyl. Of these, aqua, nitrosyl, and thionitrosyl are preferred. When aqua ligand(s) exist, it is preferable that the aqua ligand(s) occupy one or two ligand positions. Employed as transition metal coordination complex ions may be those described in paragraph Nos. Π0094┘ and ┌0095┘ of Japanese Patent Publication Open to Public Inspection No. 2001-83659.

It is preferable that light-sensitive silver halide according to the present invention is chemically sensitized. Preferred chemical sensitization may be carried out employing chemical sensitizers as well as techniques described in Japanese Patent Publication Open to Public Inspection No. 2000-112057.

It is also preferable that the light-sensitive silver halide according to the present invention is spectrally sensitized. Preferred spectral sensitization may be carried out employing sensitizing dyes as well as techniques described in paragraph Nos. ┌0099┘ through ┌0144┘ of Japanese Patent Application Open to Public Inspection No. 2001-83659.

In light-sensitive silver halide according to the present invention, supersensitizers may be employed which are dyes exhibiting no spectral sensitization or materials exhibiting no substantial absorption of visible light while effecting supersensitization. Supersensitization may be carried out employing compounds described in paragraph Nos. ┌0148┘ through ┌0152┘ of Japanese Patent Publication Open to Public Inspection No. 2001-83659.

In the present invention, other than the aforesaid supersensitizers, it is also possible to use as the supersensitizers compounds represented by General Formula (1) described in paragraph Nos. ┌0022┘ through ┌0028┘ of Japanese Patent Application No. 2000-70296 and large cyclic compounds having at least one heteroatom. Specific example of the compounds represented by aforesaid General Formula (1) are described in paragraph Nos. ┌0034┘ through ┌0039┘ of Japanese Patent Application No. 2000-70296, while large cyclic compounds, having at least one heteroatom, are described in paragraph Nos. ┌0044┘ through ┌0054┘ of the aforesaid patent application.

Employed as reducing agents (hereinafter referred to as reducing agents according to the present invention) may be those which are suitably selected from reducing agents which are know in the art in the technical field of silver salt photothermographic dry imaging materials. Specifically, when aliphatic carboxylic acid silver salts are employed as organic silver salts, preferred are polyphenols in which at least two hydroxyphenyl groups are linked via an alkylene group or sulfur, especially bisphenols in which at least two hydroxyphenyl groups which are substituted with an alkyl group (for example, methyl group, an ethyl group, a propyl group, a t-butyl group, or a cyclohexyl group) or an acyl group (for example, an acetyl group or a propionyl group) in at least one position adjacent to the hydroxy substitution position of the hydroxyphenyl group are linked via an alkylene group or sulfur.

In the present invention, hindered phenol type reducing agents are preferably employed which are described, for example, in paragraph Nos. ┌0047┘ and ┌0048┘ of Japanese Patent Publication Open to Public Inspection No. 2000-112057. The specific exemplified compounds are described in paragraph Nos. ┌0050┘ and ┌0051┘ of Japanese Patent Publication Open to Public Inspection No. 2000-112057. The used amount of reducing agents is customarily 1×10⁻² to 10 mol, and is preferably 1×10⁻² to 1.5 mol.

Binders (hereinafter referred to as binders according to the present invention) which are usable in the silver salt photothermographic dry imaging material of the present invention are transparent or translucent and are customarily colorless. The binders are comprised of natural or synthetic polymers. Listed as examples of the binders according to the present invention are natural or synthetic polymers described in paragraph No. ┌0193┘ of Japanese Patent Application Open to Public Inspection No. 2001-66725. Preferred as binders according to the present invention are polyvinyl acetals. Of these, polyvinyl butyral is particularly preferred. The used amount of the binders is preferably in the range of 15:1 to 1:2 in terms of the ratio of binders to organic silver salts, and is more preferably in the range of 8:1 to 1:1. Further, also preferably employed as the binders according to the present invention are polymer latexes. It is possible to apply to polymer latexes compounds and techniques described in paragraph Nos. ┌0194┘ through ┌0203┘ of Japanese Patent Application Open to Public Inspection No. 2001-6725.

The adhesion of binders according to the present invention is improved employing crosslinking agents, whereby it is assumed that uneven development is minimized, and fogging during storage as well as formation of print-out silver after development is retarded. It is possible to use aldehyde based, epoxy based, ethyleneimine based, vinylsulfone based, sulfonic acid ester based, acryloyl based, carbidiimido based, silane compound based crosslinking agents described in Japanese Patent Application Open to Public Inspection No. 50-96216. Preferred crosslinking agents include isocyanate based compounds, silane based compounds, epoxy compounds or acid anhydrides.

With regard to isocyanates based compounds, it is possible to employ compounds and techniques described in paragraph Nos. ┌0044┘ through ┌0054┘ of Japanese Patent Application Open to Public Inspection No. 2001-83659. With epoxy compounds, it is possible to employ compounds and techniques described in paragraph Nos. ┌0170┘ through ┌0180┘ of Japanese Patent Application Open to Public Inspection No. 2001-83659. With acid anhydrides, it is possible to employ compounds and techniques described in paragraph Nos. ┌0182┘ through ┌0187┘ of Japanese Patent Application Open to Public Inspection No. 2001-83659. With regard to silane compounds, it is possible to employ compounds and techniques described in paragraph Nos. ┌0022┘ through ┌0028┘ of Japanese Patent Application No. 2000-77904.

If desired, it is possible to employ toning agents in the silver salt photothermographic dry imaging material of the present invention. With regard to toning agents usable in the present invention, it is possible to employ compounds and techniques described in paragraph Nos. ┌0064┘ through ┌0066┘ of Japanese Patent Application Open to Public Inspection No. 2000-198757.

In order to control the amount or the wavelength distribution of light which transmits the light-sensitive layer of the silver salt photothermographic dry imaging material of the present invention, it is preferable that a filter layer is formed on the same side as the light-sensitive layer or the opposite side, or that dyes or pigments are incorporated in the light-sensitive layer. In the present invention, employed may be compounds known in the art which absorb light in various wavelength regions corresponding to the spectral sensitivity of the light-sensitive materials. For example, when the silver salt photothermographic dry imaging material of the present invention is employed as an image recording material for infrared radiation, it is preferable that squarylium dyes having a thiopyrylium nucleus and squarylium dyes having a pyrylium nucleus are employed. Further, it is possible to employ croconium dyes having a thiopyrylium nucleus and croconium dyes having a pyrylium nucleus, which are analogous to the squarylium dyes.

In the silver salt photothermographic dry imaging material of the present invention, employed as reducing agents are those having protons such as bisphenols and sulfonamidophenols. Therefore, it is preferable that compounds are incorporated which are capable of inactivating the aforesaid reducing agents by generating active species which are capable of extracting those hydrogen atoms. Preferred as colorless photo-oxidizing materials are compounds which are capable of forming free radicals as reaction active species during exposure. Employed as such compounds may be biimidazolyl compounds, disclosed in paragraph Nos. ┌0065┘ through ┌0069┘ of Japanese Patent Application No. 2000-57004 and iodonium compounds disclosed in paragraph Nos. ┌0711┘ through ┌0082┘ of Japanese Patent Application No. 2000-57004.

In the silver salt photothermographic dry imaging material of the present invention, it is possible to employ compounds which release halogen atoms as active species in such a manner that reducing agents are deactivated so that the resulting reducing agents are not capable of reducing organic silver salts to silver. Employed as specific examples of compounds which form active halogen atoms are compounds described in paragraph Nos. ┌0086┘ through ┌0102┘ of Japanese Patent Application No. 2000-57004.

In the silver salt photothermographic dry imaging material of the present invention, it is possible to employ silver saving agents. Silver saving agents refer to compounds which are capable of reducing the necessary silver amount for obtaining a definite silver image density. Various action mechanisms are offered to elucidate such silver reducing functions. Herein, compounds are preferred which enhance the covering power of developed silver. Covering power, as described herein, refers to optical density per unit amount of silver. Listed as silver saving compounds usable in the present invention are hydrazine derivatives disclosed in paragraph Nos. ┌0075┘ through ┌0081┘ of Japanese Patent Application No. 11-238293, vinyl compounds disclosed in paragraph Nos. ┌0109┘ through ┌0132┘ of Japanese Patent Application No. 11-238293, and quaternary onium compounds disclosed in paragraph Nos. ┌0150┘ through ┌0158┘ of Japanese Patent Application No. 11-238293.

The silver salt photothermographic dry imaging material of the present invention comprises a support, provided with the sublayer according to the present invention, having thereon a light-sensitive layer comprising organic silver salts, light-sensitive silver halide, reducing agents, and binders. Further, it is preferable that a non-light-sensitive layer is formed on the light-sensitive layer. For example, it is preferable that for the purpose of protecting the light-sensive layer, a protective layer is provided on the light-sensitive layer, while in order to minimize adhesion, a backing layer is provided on the opposite surface of the support. Selected as binders which are employed in such protective layer and backing layer are polymers such as cellulose acetate, cellulose acetate butyrate from the aforesaid binders which are polymers having a higher glass transition point than the light-sensitive layer, and seldom result in abrasion and deformation. Further, in order to control gradation, at least two light-sensitive layers may be provided on the one side on the support, or at least one light-sensitive layer may be provided on each side of the support.

The silver salt photothermographic dry imaging material of the present invention is preferably prepared in the following manner. Components of each of the aforesaid composition layers are dissolved or dispersed in solvents to prepare a coating composition. The resulting coating compositions are subjected to simultaneous multi-layer coating. Thereafter, the resulting coating is subjected to thermal treatment. “Simultaneous multi-layer coating”, as described herein, refers to operation described below. The coating composition of each composition layer (such as a light-sensitive layer and a protective layer), is prepared. Herein, instead of applying each of the resulting coating compositions onto a support, then drying the resulting coating, and repeating the same process for other coating compositions, all the layer coating composition are successively applied onto a support and the resulting coatings are simultaneously dried. Namely, it is preferable that an upper layer is provided before the total residual ratio of the solvent of a lower layer reaches less than or equal to 70 percent by weight.

Methods to simultaneously apply a plurality of composition layers onto a support are not particularly limited. It is possible to employ coating methods known in the art such as a bar coating method, a curtain coating method, a dip method, an air knife method, a hopper coating method, or an extrusion coating method. Of these, a pre-weighing type coating system, also called an extrusion coating method, is more preferred. Since no solvents are vaporized on a slide surface as in a slide coating system, the extrusion coating method is suitable for accurate coating as well as for organic solvent coating. The aforesaid coating methods have been described when applied to the side having the light-sensitive layer. The aforesaid methods are applied in the same manner when the backing layer is provided and the sublayer is simultaneously applied. Of course, water based solvents may be employed in the silver salt photothermographic dry imaging material of the present invention.

(Developing Conditions)

Developing conditions of the silver salt photothermographic dry imaging material of the present invention will now be described.

Developing conditions vary depending on the used devices, apparatuses or means. However, typical conditions are such that an imagewise exposed photothermographic dry imaging material is appropriately heated at a relatively high temperature. It is possible to develop latent images formed by exposure upon being heated, for example, at 80 to 200° C., preferably at 100 to 200° C. from about 1 second to about 2 minutes. When the heating temperature is at most 80° C., sufficient image density is not obtained during a short time. On the other hand, when the heating temperature is at least 200° C., binders may melt and be transferred onto the rollers. As a result, images, conveyance properties, and processors are adversely affected. Heating forms silver images according to an oxidation-reduction reaction between organic silver salts (which function as an oxidizing agent) and reducing agents.

The aforesaid reaction process proceeds without any exterior supply of processing liquid such as water. Heating devices, apparatuses, and means include typical heating means such as hot plates, irons, hot rollers, and heat generators employing carbon or white titanium. When the silver salt photothermographic dry imaging material of the present invention comprises a protective layer, from the viewpoint of uniform heating, heating efficiency, and workability, it is preferable that heating is carried out in such a manner that the surface of the side having the protective layer is brought into contact with a heating means. Further, it is preferable that development is carried out employing a heating process while the aforesaid surface is brought into contact with a heating roller.

During development, the silver salt photothermographic dry imaging material of the present invention solvents is prepared so that the amount of solvents is 5 to 1,000 mg/m² and preferably 100 to 500 mg/m². By so doing, the silver salt photothermographic dry imaging material results in high speed, lower fog, and higher maximum density.

Listed as solvents are ketones such as acetone, methyl ethyl ketone, and isophorone; alcohols such as methyl alcohol, ethyl alcohol, isopropyl alcohol, cyclohexanol, and benzyl alcohol; glycols such as ethylene glycol, diethylene glycol, triethylene glycol, propylene glycol, and hexylene glycol; ether alcohols such as ethylene glycol monomethyl ether and diethylene glycol monoethyl ether; ethers such as isopropyl ether; esters such as ethyl acetate and butyl acetate; chlorides such as methylene chloride and dichlorobenzene; and hydrocarbons. Other than these, listed are water, formamide, dimethylformamide, toluidine, tetrahydrofuran, and acetic acid. However, the present invention is not limed to these examples. Further, these solvents may be employed individually or in combination of several types.

It is possible to control the content of the aforesaid solvents in the silver salt photothermographic dry imaging material, employing a variation of conditions such as temperature during the drying process after the coating process. Further, it is possible to measure the content of the aforesaid solvent, utilizing gas chromatography under conditions which are suitable for detecting incorporated solvents.

(Other Conditions and Items)

Exposure conditions for the silver salt photothermographic dry imaging material of the present invention will now be described. When the silver salt photothermographic dry imaging material of the present invention is exposed to radiation, it is preferable to employ an appropriate light source for spectral sensitivity provided to the aforesaid silver salt photothermographic dry imaging material of the present invention. For example, when the material is sensitive to infrared radiation, it is possible to employ the aforesaid material for any radiation source which emits infrared radiation. However, infrared semiconductor lasers are preferably employed, since such lasers emit high intensity radiation and it is possible to make the silver salt photothermographic dry imaging material transparent.

It is preferable that the silver salt photothermographic dry imaging material of the present invention is exposed to radiation employing laser scanning exposure. Various exposure methods may be employed.

Listed as the primarily preferable method is a method in which a laser scanning exposure apparatus is employed in which the angle between the exposure surface of the silver salt photothermographic dry imaging material of the present invention and the scanning laser beam does not substantially become vertical. “Does not substantially become vertical”, as described herein, means that during laser scanning, the nearest vertical angle is preferably 55 to 88 degrees, is more preferably 60 to 86 degrees, and is most preferably 70 to 82 degrees. When the laser beam scans light-sensitive materials, the beam spot diameter on the exposed surface of the light-sensitive material is preferably at most 200 μm, and is more preferably at most 100 mm, and is most preferably at most 100 μm. It is preferable to decrease the spot diameter due to the fact that it is possible to decrease the deviation angle from verticality of the laser beam incident angle. The lower limit of the laser beam spot diameter is 10 μm. By performing such laser beam scanning exposure, it is possible to minimize degradation of image quality due to reflection light such as generation of unevenness analogous to interference fringes.

As a second method, exposure is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode. The longitudinal multiple mode is preferably achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

As a third embodiment, it is preferable that images are formed by scanning exposure, employing at least two laser beams. The image recording method employing a plurality of laser beams is comprised of techniques employed in laser printers as well as digital copiers in which images are formed employing a plurality of lines during a single scanning to meet demands for enhancement of resolution as well as increase in speed. Such techniques are disclosed, for example, in Japanese Patent Publication Open to Public Inspection No. 60-166916. In the aforesaid method, a laser beam emitted from a laser beam source is deflected by a polygonal mirror and is scanned so as to form images on a photoreceptor via a fθ lens, and the like. Laser scanning optical apparatuses in which the aforesaid method is employed includes laser imagers utilizing the same principle. In the image writing means of laser printers and digital copiers, images are formed on the silver salt photothermographic dry imaging materials is in such a manner that, for the use of writing images utilizing a plurality of lines during one scanning, the subsequent laser beam forms an image shifted by one line from the image forming position by the prior laser beam. Specifically, two laser beams approach at a distance of several 10 μm on the image surface in the secondary scanning direction. Printing density is 400 dpi (herein, printing density of 1 dot per inch, i.e., 2.54 cm is defined as dpi (dot per inch)) and pitch in the secondary scanning direction of two beams is 63.5 μm and 42.3 μm at 600 dpi.

Being different from the method in which shift in the secondary scanning direction is carried out corresponding to the magnitude of resolution, it is also preferable that at least two laser beams converge onto the exposure surface while varying each of the incident angles to form images. In such a case, it is preferable to satisfy the relationship described below:

0.9×E≦En×N≦1.1×E

wherein E is the exposure energy on the exposure surface when an image is written employing one laser beam (having a wavelength λ in nm), N is the number of laser beams having the same wavelength (wavelength λ in nm) employed for exposure, and En is the exposure energy of each laser beam, which is the same as each other. By satisfying the above relationship, it is possible to assure energy on the exposure surface. Reflection of each laser beam to the image forming layer decreases due to low exposure energy of the laser beam whereby it is possible to minimize the generation of interference fringes. In the above description, a plurality of laser beams having the same wavelength λ is employed. However, it is possible to use laser beams having different wavelengths. In such a case, it is preferable that λ in nm satisfies the following relationship:

(λ−30)<λ1, λ2, . . . λn<(λ+30)

In the exposure methods of the aforesaid primary, secondary, and tertiary embodiments, it is possible to select any of the following suitable lasers which are generally well known, while matching the use. The lasers include solid lasers such as a ruby laser, a YAG laser, and a glass laser; gas lasers such as an He—Ne laser, an Ar ion laser, a Kr ion laser, a CO₂ laser, a CO laser, an He—Cd laser, an N₂ laser, and an excimer laser; semiconductor lasers such as an InGaP laser, an AlGaAs laser, a GaAsP laser, an InGaAs laser, an InAsP laser, a CdSnP₂ laser, and a GaSb laser; chemical lasers; and dye lasers. Of these, from the viewpoint of maintenance as well as the size of light sources, it is preferable to employ any of the semiconductor lasers having a wavelength of 600 to 1,200 nm.

The beam spot diameter of lasers employed in laser imagers, as well as laser image setters, is commonly in the range of 5 to 75 μm in terms of the short axis diameter and in the range of 5 to 100 μm in terms of the long axis diameter. Further, it is possible to set the laser beam scanning rate at the optimal value for each light-sensitive material depending on the inherent speed of the silver salt photothermographic dry imaging material at the laser transmitting wavelength and the laser power.

In the present invention, a formed non-image forming sublayer may be electrically conductive. Preferably listed are minute particles comprised of metal oxides such as oxygen insufficient oxides, metal surplus oxides, metal insufficient oxides, and oxygen surplus oxides which tend to form non-stoichiometric compounds. Of these, metal oxides which are most suitable for the present invention are minute metal oxide particles which make it possible to employ various systems such as production methods. Commonly employed as metal oxides are crystalline metal oxides which include ZnO, TiO₂, SnO₂, Al₂O₃, In₂O₃, SiO₂, MgO, B₂O, and MoO₃, and composite oxides thereof. Of these, ZnO, TiO₂, and SnO₂ are preferred. Preferred as composite oxides are ZnO comprising Al and In, TiO₂ comprising Nb and Ta, and SnO₂ comprising Sb, Nb, and halogens, in which the proportion of foreign elements is preferably 0.01 to 30 mol percent, and is more preferably 0.1 to 10 mol percent.

The volume resistivity of these minute metal oxide particles is preferably at most 10⁷ Ω·cm, and is more preferably 10⁵ Ω·cm. Those which have oxygen defects in their crystals and which comprise a small amount of foreign atoms, which function as so-called donors for the aforesaid metal oxide, are preferably incorporated due to an increase in conductivity. Production methods of such minute metal oxide particles are detailed, for example, in Japanese Patent Publication Open to Public Inspection No. 56-143430.

Such minute metal oxide particles increase electrical conductivity. On the other hand, it is necessary to take into account the particle diameter as well as the ratio of particles/binders for light scattering. Further, haze is enhanced and it is difficult to prepare the dispersion. As a result, it is more preferable to use inorganic colloids which exist as colloids in water. Inorganic colloids, as described herein, refer to those defined in “Kagaku Daijiten (ENCYCLOPEDIA CHIMICA)”, published by Kyoritsu Shuppan and those which comprise from 10⁵ to 10⁹ atoms per particle.

Depending on elements, metal colloids, oxide colloids or hydroxide colloids are prepared. Gold, palladium, platinum, silver and sulfur are preferably employed to prepare the metal colloids. Oxide colloids, hydroxide colloids, carbonate colloids, and sulfate colloids of zinc, magnesium, silicon, calcium, aluminum, strontium, barium, zirconium, titanium, manganese, iron, cobalt, nickel, tin, indium, molybdenum, and vanadium are preferably employed in the present invention. Specifically, ZnO, TiO₂, and SnO₂ are preferred. Of these, SnO₂ is most preferred. Further, listed as examples of foreign atoms employed for doping are Al and In for ZnO, Nb and Ta for TiO₂, and Sb, Nb, and halogen atoms for SnO₂. The average diameter of inorganic colloid particles is preferably 0.001 to 1 μm from the viewpoint of dispersion stability.

The metal oxide colloids, especially colloidal SnO₂ sol comprised of stannic oxide are prepared employing either a method in which ultra-minute SnO₂ particles are dispersed in suitable solvents, or a method in which solvent-soluble Sn compounds undergo dispersion reaction in solvents.

In regard to the production method of ultra-minute SnO₂ particles, temperature conditions are particularly critical. A method which accompanies a thermal process at high temperature is not preferred due to generation of phenomena such as growth of primary particles as well as enhancement of crystallinity. Unavoidably when it necessary to carry out a thermal process, the thermal process is customarily carried out at less than or equal to 300° C., preferably at less than or equal to 200° C., and more preferably at less than 150° C or equal to 150° C. When taking into account dispersion into binders, heating from 25 to 150° C. is an optimally selected means.

A production method utilizing a decomposition reaction of solvent-soluble Sn compounds in solvents will now be described. Solvent-soluble Sn compounds, as described herein, refer to oxo negative ion-containing compounds such as K₂SnO₃.3H₂O, water-soluble halides such as SnCl₄, and compounds having a structure such as R′₂SnR₂, R₃SnX and R₂SnX₂ (wherein R and R′ each represents an alkyl group), which may include organic metal compounds such as (CH₃)₃SnCl.(pyridine) and (C₄H₉)₂Sn(O₂CC₂H₅) and oxo salts such as Sn(SO₄)₂.2H₂O. Methods in which SnO₂ sol is produced employing such solvent-soluble Sn compounds include a physical method in which after dissolving in solvents, heat or pressure is applied to the resulting composition, a chemical method in which oxidation, reduction or hydrolysis is employed, and a method in which SnO2 is produced via intermediates. It is possible to apply to the metal oxides of the present invention a SnO₂ sol production method described in Japanese Patent Publication No. 35-6616.

### EXAMPLES

The present invention will now be detailed with reference to examples. However, the present invention is not limited to these examples.

<<Preparation of Hydrophilic Polyester Solutions A-1 through A-4>>

As described below, aqueous polyester dispersions (refer to Table 1 regarding types and added amounts) were prepared (at solids of 15 percent).

(Preparation of Hydrophilic Polyester Solution A-1)

A mixture consisting of 35.4 parts by weight of dimethyl terephthalate, 33.63 parts by weight of dimethyl isophthalate, 17.92 parts by weight of dimethyl 5-sufoisophthalate sodium salt, 62 parts by weight of ethylene glycol, 0.065 part by weight of calcium acetate monohydrate, and 0.022 part by weight of manganese acetate underwent transesterification at 170 to 220° C. under nitrogen gas flow, while methanol being distilled away. Thereafter, 0.04 parts by weight of trimethyl phosphate, 0.04 part by weight of antimony trioxide, as a polymerization condensation catalyst, and 6.8 parts by weight of 4-cyclohexanedicarboxylic acid were added and the resulting mixture underwent esterification at a reaction temperature of 220 to 235° C., while the theoretical amount of water was distilled away.

Thereafter, the pressure of the reaction system was reduced over one hour and the temperature was raised. Subsequently, polymerization condensation was performed at 280° C. and 133 Pa for one hour to prepare Hydrophilic Polyester A-1. The obtained Hydrophilic Polyester A-1 exhibited an intrinsic viscosity of 0.33 (100 ml/g) and Mw of 80,000 to 100,000.

Subsequently, charged into a 2-liter three-necked flask fitted with a stirring blade, a reflux condenser, and a thermometer was 850 ml of pure water. Subsequently, 150 g of Hydrophilic Polyester A-1 was gradually added, under constant stirring. After stirring without modification at room temperature for 30 minutes, the internal temperature was raised to 98° C. over one and a half hours and Hydrophilic Polyester A-1 was dissolved over 3 hours while maintaining a temperature at 98° C. After completion of heating, the reaction mixture was cooled to room temperature over one hour and was allowed to stand overnight, whereby a 15 percent by weight of Hydrophilic Polyester A-1 Solution was prepared. A-2 through A-4 were prepared in the same manner as A-1, except that the monomer compositions were changed.

<<Preparation of Hydrophilic Polyester Solution A-5>>

As described below, aqueous polyester dispersions (refer to Table 1 regarding types and added amounts) were prepared (at solids of 15 percent).

Charged into a transesterification vessel were a mixture consisting of 70 mol percent of dimethyl 2,6-naphthalenedicarrboxylate, 27 mol percent of dimethyl isophthalate, 3 mol percent of trimellitic anhydride, 95 mol percent of ethylene glycol, and 5 mol percent of an ethylene oxide addition product (having a structure of ┌Ka 1┘ and an average value of 4 of m+n, also described as Surfactant (A)) and further 0.05 part of tetrabutoxy titanium was added. The resulting mixture underwent transesterification reaction under a flow of nitrogen at 230° C. while distilling away methanol.

Subsequently, after adding 0.6 part by weight of Ilganox 1010 (manufactured by Ciba-Geigy Ltd.) to this reaction system, the resulting mixture was gradually heated to 255° C., and then underwent polymerization condensation under a reduced pressure of 133 kPa, whereby a polyester resin having an intrinsic viscosity of 0.32 was prepared.

Dissolved in 180 parts by weight of tetrahydrofuran was 20 parts by weight of the resulting polyester resin. Subsequently, 180 parts by weight of a 0.4 weight percent aqueous triethylamine solution was dripped into the resulting mixture at a high speed stirring of 10,000 rpm, whereby a bluish milky dispersion was obtained. The resulting dispersion was then distilled under a reduced pressure of 2,660 kPa to remove tetrahydrofuran. Thus a water based polyester dispersion, having 15 weight percent solids, was obtained.

<<Preparation of Hydrophilic Polyester Solution A-6>>

Pesresin A-515 GB (modified hyrdophilic polyester having a Tg of 60° C., manufactured by Takamatsu Yusi Co.) was dissolved in water so as to solids of 15 percent by weight.

Employed polyester compositions (in mol percent)

TABLE 1

| | | | | | | | | | | | Tg |
|---|---|---|---|---|---|---|---|---|---|---|---|
| Component | TA | IA | IPS | CHDA | QA | TMA | EG | DEG | CHDM | BPA | (° C.) |
| A-1 | 40 | 38 | 14 | 8 | | | 100 | | | | 51 |
| A-2 | 40 | 30 | 10 | 20 | | | 70 | | 30 | | 56 |
| A-3 | 50 | 42 | 8 | | | | | 80 | 20 | | 80 |
| A-4 | 40 | 40 | 20 | | | | | 40 | 60 | | 73 |
| A-5 | | 27 | | | 70 | 3 | 95 | | | 5 | 55 |

| | |
|---|---|
| A-6 | Pesresin A-515GB (modified hydrophilic polyester having a Tg of 60° C., |
| | manufactured by Takamatsu Yusi Co.) was adjusted to solids of 15 percent by |
| | weight by adding water. |

TA: dimethyl terephthalate
IA: dimethyl isophthalate
IPS: sodium dimethyl 5-sulfoisophthalate
CHDA: 4-cylcohexanedicarboxylic acid
QA: 2,6-naphthalenedicarboxylic acid
TMA: trimellitic anhydride
EG: ethylene glycol
DEG: diethylene glycol
CHDM: cyclohexanedimethanol
BPA: bisphenol A ethylene oxide additive product

<<Preparation of Modified Hydrophilic Polyester Solutions B-1 through B-7>>

(Preparation of Modified Hydrophilic Polyester Solution B-1)

Charged into a 3-liter four-necked flask fitted with stirring blades, a reflux condenser, a thermometer and a dripping funnel was 1,900 ml of 15 percent by weight Hydrophilic Polyester Solution A-2, and the resulting mixture was heated to 80° C. while stirring. Added to the above mixture was 6.52 ml of 24 percent aqueous ammonium peroxide, and then over 30 minutes dripped into the resulting mixture was a monomer mixed composition (consisting of 28.5 g of glycidyl methacrylate, 21.4 g of ethyl acrylate, and 21.4 g of methyl methacrylate). The resulting mixture underwent reaction for an additional 3 hours. Thereafter, the resulting mixture was cooled to less than or equal to 30° C. and filtered, whereby Modified Hydrophilic Polyester Solution B-1 was prepared (exhibiting a vinyl based component modification ratio of 20 percent by weight) having a solid concentration of 18 percent by weight.

(Preparation of Modified Hydrophilic Polyester Solution B-2)

Charged into a 3-liter four-necked flask fitted with stirring blades, a reflux condenser, a thermometer and a dripping funnel was 1,900 ml of 15 percent by weight Hydrophilic Polyester Solution A-2, and the resulting mixture was heated to 80° C. while stirring. Added to the above mixture was 6.52 ml of 24 percent aqueous ammonium peroxide, and then over 30 minutes dripped into the resulting mixture was a monomer mixed composition (consisting of 10.7 g of styrene, 28.5 g of glycidyl methacrylate, 21.4 g of ethyl acrylate, and 10.7 g of methyl methacrylate). The resulting mixture underwent reaction for an additional 3 hours. Thereafter, the resulting mixture was cooled to less than or equal to 30° C. and filtered, whereby Modified Hydrophilic Polyester Solution B-2 was prepared (exhibiting a vinyl based component modification ratio of 20 percent by weight) having a solid concentration of 18 percent by weight.

(Preparation of Modified Hydrophilic Polyester Solution B-3)

Charged into a 3-liter four-necked flask fitted with stirring blades, a reflux condenser, a thermometer and a dripping funnel was 1,900 ml of a 15 percent by weight Hydrophilic Polyester Solution A-2, and the resulting mixture was heated to 80° C. while stirring. Added to the above mixture was 6.52 ml of 24 percent aqueous ammonium peroxide, and then over 30 minutes dripped into the resulting mixture was a monomer mixed composition (consisting of 28.5 g of styrene, 28.5 g of glycidyl methacrylate, and 14.4 g of acrylamide). The resulting mixture underwent reaction for an additional 3 hours. Thereafter, the resulting mixture was cooled to less than or equal to 30° C. and filtered, whereby Modified Hydrophilic Polyester Solution B-3 was prepared having a solid concentration of 18 percent by weight.

(Preparation of Modified Hydrophilic Polyester Solution B-4)

Modified Hydrophilic Polyester Solution B-4 was prepared in the same manner as Modified Hydrophilic Polyester Solution B-1, except that the vinyl based component modification ratio was changed to 8 percent by weight.

(Preparation of Modified Hydrophilic Polyester Solution B-5)

Modified Hydrophilic Polyester Solution B-4 was prepared in the same manner as Modified Hydrophilic Polyester Solutions B-1, except that the vinyl based component modification ratio was changed to 12 percent by weight.

(Preparation of Modified Hydrophilic Polyester Solution B-6)

Modified Hydrophilic Polyester Solution B-6 was prepared in the same manner as Modified Hydrophilic Polyester Solutions B-1, except that the hydrophilic polyester solution was replaced with A-3.

(Preparation of Modified Hydrophilic Polyester Solution B-7)

Modified Hydrophilic Polyester Solution B-7 was prepared in the same manner as Modified Hydrophilic Polyester Solutions B-1, except that the hydrophilic polyester solution was replaced with A-4.

<<Preparation of Vinyl Based Polymer Latexes C-2 through C-4>>

Polymer Latexes C-1 through C-4, having the monomer compositions described below, were synthesized employing emulsion polymerization. All the solid concentrations were adjusted to 30 percent by weight.

TABLE 2

| | | Tg (° C.) |
|---|---|---|
| C-1 | styrene:glycidyl methacrylate:n-butyl acrylat = | 20 |
| | 20:40:40 | |
| C-2 | styrene:n-butyl acrylate:t-butyl acrylate:hydroxy- | 55 |
| | ethyl methacrylate = | |
| | 27:10:35 | |
| C-3 | styrene glycidyl methacrylate:aceto- | 50 |
| | acetoxyethyl methacrylate = | |
| | 40:40:20 | |
| C-4 | ethyl acrylate:methyl methacrylate = | — |
| | 50:50 | |

<<Polyvinyl Alcohol Unit Containing Hydrophilic Polymers>>

D-1: PVA-110 aqueous dispersion (5 percent solids) manufactured by Kuraray Co.: degree of saponification 98.5

D-2: PVA-617 aqueous dispersion (5 percent solids) manufactured by Kuraray Co.: degree of saponification 95

D-3: PVA-205 aqueous dispersion (5 percent solids) manufactured by Kuraray Co.: degree of saponification 88

D-4: RS-4105 aqueous dispersion (5 percent solids) manufactured by Kuraray Co.: degree of saponification 98

D-5: RS-2117 aqueous dispersion (5 percent solids) manufactured by Kuraray Co.: degree of saponification 98

<<Styrene-Diolefin Based Copolymers>>

E-1: styrene butadiene latex (Nippol LX432A, 40 percent solids, manufactured by Nihon Zeon Co.)

E-2: styrene-butadiene copolymer latex (having a weight ratio of styrene/butadiene of 68/32, 40 percent solids)

<<Polyurethane Component Containing Hydrophilic Polymers>>

F-1: hydrophilic polyurethane (W-6015, manufactured by Takeda Yakuhin Kogyo Co.)

F-2: hydrophilic polyurethane (W-7004, manufactured by Takeda Yakuhin Kogyo Co.)

F-3: hydrophilic polyurethane (Superflex 820, manufactured by Daiichi Kogyo Seiyaku Co.)

<<Preparation of G-1 (SnO₂ Sol)>>

SnO₂ sol which was synthesized according the method described in Example 1 of Japanese Patent Publication No. 35-6616 was concentrated to obtain solids 10 percent by weight. Thereafter, the pH was adjusted to 10 and then employed.

### Example 1

PET having an intrinsic viscosity IV of 0.66 (determined in phenol/tetrachloroethane=6/4 in terms of weight ratio at 25° C.) was prepared employing phthalic acid and ethylene glycol while using a conventional method. The resulting PET was pelletized and dried at 140° C. for 4 hours. The resulting pellets were melted at 300° C., and then quickly cooled while being extruded from a T type die, whereby a non-stretched film was prepared so as to obtain a layer thickness of 175 μm after thermal fixing. The resulting film was subjected to longitudinal stretching by a factor of 3.3, employing rollers having different peripheral rates and was then subjected to lateral stretching by a factor of 4.5 employing a tenter. During the aforesaid operations, temperatures were 110° C. and 130° C., respectively. Thereafter, thermal fixing was performed at 240° C. for 20 seconds and 4 percent lateral relaxation was performed at the same temperature. Thereafter, the chuck portion of the tenter was removed through slitting and both sides were subjected to a knurl treatment. The resulting film was wound under 4 kg/cm², whereby a roll of 175 μm thick film to be employed as a support was obtained.

(Preparation of a Subbed Photographic Support)

A 175 μm thick biaxially oriented thermally fixed polyethylene terephthalate blue tinted film at a density of 0.170 (measured by Densitometer PDA-65, manufactured by Konica Corp.), which was employed as a photographic support, was subjected to a corona discharge treatment of 8 W/cm-minute on both sides. The resulting film was subjected to a subbing treatment. Namely, subbing coating composition a-1 was applied onto one side of the aforesaid photographic support so as to obtain a dried layer thickness of 0.2 μm and subsequently dried at 123° C. to form a sublayer on the light-sensitive layer side. The resulting sublayer was designated as Sublayer A-1.

Further, sublayer coating composition b-1, described below, was applied onto the surface of the opposite side to form a backing layer sublayer to obtain a dried layer thickness of 0.12 μm, and subsequently dried at 123° C., whereby a conductive sublayer exhibiting an antistatic function was formed on the backing layer side. The resulting sublayer was designated as Sublayer B-1.

Both surfaces of Sublayers A-1 and B-1 were subjected to a corona discharge of 8 W/m²·minute. Subsequently, sublayer coating composition a-2, described below, was applied onto Sublayer A-1 to obtain a dried layer thickness of 0.1 μm, and subsequently dried at 123° C. The resulting sublayer was designated as Upper Sublayer A-2.

Further, subbing coating composition b-2, described below, was applied onto Sublayer B-1 to obtain a dried layer thickness of 0.2 μm and subsequently dried at 123° C. The resulting coating was designated as Upper Sublayer B-2. Furthermore, the support was subjected to a thermal treatment at 123° C. for two minutes, whereby Subbed Sample 1-1 was prepared.

Subbed Samples 1-2 through 1-9, 1-32 and 1-33 were prepared in the same manner as Subbed Sample 1-1, except that binders constituting Upper Sublayer A-2 on the light-sensitive layer side were changed as shown in Tables 3 and 4.

Further, Subbed Samples 1-10 through 1-26, 1-31, and 1-34 were prepared in such a manner that without coating the lower sublayer, Upper Sublayer A-2 was directly applied onto the corona discharged surface as shown in Tables 3 and 4.

Further, Subbed Samples 1-27 through 1-30 were prepared in such a manner that the coating temperature of Upper Sublayer A-2 was changed as shown in Table 3.

| (Sublayer Coating Composition b-1 on Backing Layer Side) | |
|---|---|
| Acryl based polymer latex C-1 (solids 30 | 30.0 g |
| percent | |
| Acryl based polymer latex C-2 (solids 30 | 7.6 g |
| percent) | |
| SnO₂ sol (G-1) | 180 g |
| Surfactant (A) | 0.5 g |
| 5 percent aqueous PVA-613 (PVA, manufactured | 0.4 g |
| by Kuraray Co.) solution | |

Distilled water was added to the above components and the total volume was adjusted to one liter, whereby a coating composition was prepared.

| (Upper Sublayer Coating Composition b-2 on the Backing Layer | |
|---|---|
| Side) | |
| Modified hydrophilic polyester B-1 (solids 18 | 215 g |
| percent) | |
| Spherical silica matting agent Sea Hoster | 0.3 g |
| KE-P50, manufactured by Nihon Shokubai | |
| Co.) | |
| Surfactant (A) | 0.4 g |

Distilled water was added to the above components for a total volume of one liter, whereby a coating composition was prepared.

| (Lower Sublayer Coating Composition a-1 on the Image Forming | |
|---|---|
| Layer Side) | |
| Acryl based polymer latex C-3 (solids 30 | 70.0 g |
| percent) | |
| Acryl based polymer latex C-1 (solids 30 | 3.7 g |
| percent) | |
| Aqueous dispersion of ethoxylated alcohol | 5.0 g |
| and ethylene homopolymer (solids 10 percent) | |
| Surfactant (A) | 0.1 g |

Distilled water was added to the above components for a total volume of one liter, whereby a coating composition was prepared.

| (Upper Sublayer Coating Composition a-2 on the Image Forming | |
|---|---|
| Layer Side) | |
| Modified Hydrophilic Polyester B-1 (solids 18 | 130 g |
| percent) | |
| Surfactant (A) | 0.4 g |
| Spherical silica matting agent (Sea Hoster | 0.3 g |
| KE-P50, manufactured by Nihon | |
| Shokubai Co.) | |

Distilled water was added to the above components for a total volume of one liter, whereby a coating composition was prepared.

<<Preparation of Solvent Based Silver Salt Photothermographic Imaging Material Samples 1-1 through 1-23, 1-35, and 1-37>>

As shown in Tables 3 and 4, Silver Salt Photothermographic Dry Imaging Material Samples 1-1 through 1-23, and 1-35 through 1-37 were prepared by applying the backing layer, the light-sensitive layer, and the protective layer onto Subbed Samples 1-1 through 1-19, 1-27 through 1-30, and 1-32 through 1-34.

<<Preparation of Water Based Silver Salt Photothermographic Imaging Material Samples 1-24 through 1-33, 1-34, and 1-38>>

As shown in Table 3, Silver Salt Photothermographic Dry Imaging Material Samples (hereinafter occasionally referred to as Photographic Material Samples) 1-24 through 1-33, 1-34, and 1-38 were prepared by applying the backing layer, the light-sensitive layer, and the protective layer onto Subbed Samples 1-10 through 1-13, 1-20 through 1-26, and 1-31 through 1-34.

TABLE 3

| | | Sublayer on Light-Sensitive Layer Side | | | | | | | |
|---|---|---|---|---|---|---|---|---|---|
| | | | Upper Sublayer | | | | | | |
| | | Presence | Binder | | | | | | |
| Photographic | Subbed | or Absence | 1 | Ratio | Binder | Ratio | | | |
| Material | Sample | of | Poly- | Vol. | 2 | Vol. | *1 | Coating | |
| Sample No. | No. | Sublayer | ester | percent | Type | percent | ° C. | Composition | Remarks |
| 1-1 | 1-1 | presence | A-1 | 100 | — | — | 20 | solvent based | Inv. |
| 1-2 | 1-2 | presence | A-2 | 100 | — | — | 20 | solvent based | Inv. |
| 1-3 | 1-3 | presence | A-3 | 100 | — | — | 20 | solvent based | Inv. |
| 1-2 | 1-2 | presence | A-5 | 100 | — | — | 20 | solvent based | Inv. |
| 1-4 | 1-4 | presence | A-1 | 90 | C-2 | 10 | 20 | solvent based | Inv. |
| 1-5 | 1-5 | presence | A-2 | 90 | C-2 | 10 | 20 | solvent based | Inv. |
| 1-6 | 1-6 | presence | A-3 | 90 | C-2 | 10 | 20 | solvent based | Inv. |
| 1-7 | 1-7 | presence | A-1 | 50 | C-4 | 50 | 20 | solvent based | Inv. |
| 1-8 | 1-8 | presence | A-1 | 10 | C-2 | 90 | 20 | solvent based | Inv. |
| 1-9 | 1-9 | presence | | — | C-2 | 100 | 20 | solvent based | Comp. |
| 1-35 | 1-32 | presence | A-1 | 100 | — | — | 20 | solvent based | Inv. |
| 1-36 | 1-33 | presence | A-1 | 97. 5 | — | — | 20 | solvent based | Inv. |
| 1-10 | 1-10 | absence | A-1 | 100 | — | — | 20 | solvent based | Comp. |
| 1-11 | 1-27 | absence | A-1 | 100 | — | — | 25 | solvent based | Inv. |
| 1-12 | 1-28 | absence | A-1 | 100 | — | — | 30 | solvent based | Inv. |
| 1-13 | 1-29 | absence | A-1 | 100 | — | — | 35 | solvent based | Inv. |
| 1-14 | 1-30 | absence | A-1 | 100 | — | — | 38 | solvent based | Comp. |

*1: Coating Composition Temperature
Inv.; Present Invention
Comp.; Comparative sample

TABLE 4

| | | Sublayer on Light-Sensitive Layer Side | | | | | | | |
|---|---|---|---|---|---|---|---|---|---|
| | | | Upper Sublayer | | | | | | |
| | | Presence | Binder | | | | | | |
| Photographic | Subbed | or Absence | 1 | Ratio | Binder | Ratio | | | |
| Material | Sample | of | Poly- | Vol. | 2 | Vol. | *1 | Coating | |
| Sample No. | No. | Sublayer | ester | percent | Type | percent | ° C. | Composition | Remarks |
| 1-15 | 1-11 | absence | A-6 | 100 | — | — | 20 | solvent based | Comp. |
| 1-16 | 1-12 | absence | A-4 | 100 | — | — | 20 | solvent based | Comp. |
| 1-17 | 1-13 | absence | A-5 | 100 | — | — | 20 | solvent based | Inv. |
| 1-18 | 1-14 | absence | A-1 | 90 | C-3 | 10 | 20 | solvent based | Inv. |
| 1-19 | 1-15 | absence | A-6 | 90 | C-3 | 10 | 20 | solvent based | Inv. |
| 1-20 | 1-16 | absence | A-4 | 90 | C-3 | 10 | 20 | solvent based | Inv. |
| 1-21 | 1-17 | absence | A-1 | 50 | C-3 | 50 | 20 | solvent based | Inv. |
| 1-22 | 1-18 | absence | A-1 | 10 | C-3 | 90 | 20 | solvent based | Inv. |
| 1-23 | 1-19 | absence | | — | C-3 | 100 | 20 | solvent based | Comp. |
| 1-37 | 1-34 | absence | A-1 | 97.5 | — | — | 20 | solvent based | Inv. |
| 1-24 | 1-10 | absence | A-1 | 100 | — | — | 20 | water based | Comp. |
| 1-25 | 1-20 | absence | A-3 | 100 | — | — | 20 | water based | Comp. |
| 1-26 | 1-12 | absence | A-4 | 100 | — | — | 20 | water based | Comp. |
| 1-27 | 1-13 | absence | A-5 | 100 | — | — | 20 | water based | Inv. |
| 1-28 | 1-21 | absence | A-1 | 90 | C-1 | 10 | 20 | water based | Inv. |
| 1-29 | 1-22 | absence | A-3 | 90 | C-1 | 10 | 20 | water based | Inv. |
| 1-30 | 1-23 | absence | A-4 | 90 | C-1 | 10 | 20 | water based | Inv. |
| 1-31 | 1-24 | absence | A-1 | 50 | C-4 | 50 | 20 | water based | Inv. |
| 1-32 | 1-25 | absence | A-1 | 10 | C-1 | 90 | 20 | water based | Inv. |
| 1-33 | 1-26 | absence | — | — | C-1 | 100 | 20 | water based | Comp. |
| 1-34 | 1-31 | absence | — | — | C-4 | 100 | 20 | water based | Comp. |
| 1-38 | 1-34 | absence | A-1 | 97.5 | — | — | 20 | water based | Inv. |

*1: Coating Composition Temperature
Inv.; Present Invention
Comp.; Comparative sample

In Tables 3 and 4,

(1) The dried thickness of all the coated Lower Sublayers was 0.2 μm. C-2/C-1 of Subbed Samples 1-1 through 1-9 and 1-33 was 95/5 (in percent by weight), and C-2/C-1 of Subbed Samples 1-32 was 92.5/2.5 (in percent by weight).

(2) The dried thickness of all the Upper Sublayers was 0.2 μm. Polyester A-1 (97.5 percent by volume) and Inorganic Filler G-1 (2.5 percent by volume) were added to Subbed Samples 1-33 and 1-34.

<Formation of Backing Layer>

The backing layer coating composition described below was applied onto the lower backing sublayer, which was previously provided, to obtain a dried layer thickness of 3.5 μm, employing an extrusion coater and subsequently dried (employing drying air flow at a drying temperature of 100° C. and a dew point of 10° C. over 5 minutes), whereby a backing layer was formed.

<<Preparation of a Backing Layer Coating Composition>>

While stirring, added to 830 g of methyl ethyl ketone were 84.2 g of cellulose acetate butyrate (CAB281-20, manufactured by Eastman Chemical Co.) and a polyester resin (Vitel PE2200B, manufactured by Bostic Co.), and allowed to dissolve. Subsequently, added to the resulting solution were 0.30 g of Infrared Dye 1 and then 4.5 g of a fluorine based surfactant (Surfron KH40, manufactured by Asahi Glass Co.) and 2.3 g of a fluorine based surfactant (Megafag F120K, manufactured by Dainippon Ink Co.) which had been dissolved in 43.2 g of methanol. The resulting mixture was sufficiently stirred until the added compounds were completely dissolved. Finally 75 g of silica (Siloid 64×6000, manufactured by W. R. Grace Co.) which had been dispersed at a concentration of one percent by weight in methyl ethyl ketone, employing a dissolver type homogenizer, was added while stirring, whereby a backing layer coating composition was prepared.

Infrared Dye 1

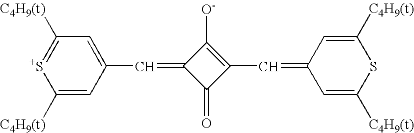

<Formation of Layers on the Light-Sensitive Layer Side>

The light-sensitive coating composition and the surface protective layer coating composition, described below, were subjected to simultaneous multilayer coating onto the surface of Upper Sublayer A-2 on the light-sensitive layer side of the aforesaid photographic support previously provided with the backing layer, employing an extrusion coater, whereby a silver salt photothermographic dry imaging material was prepared. Coating was carried out to obtain a silver coverage on the light-sensitive layer of 1.9 g/m² and a thickness of the surface protective layer of 2.5 μm. Thereafter, the resulting coating was dried for 10 minutes, employing a drying air flow having a drying temperature of 75° C. and a dew point of 10° C., whereby Silver Salt Photothermographic Dry Imaging Material Samples 1-1 through 1-23 were prepared.

(Preparation of Light-Sensitive Silver Halide Emulsion A)

| | | |
|---|---|---|
| Solution (A1) | | |
| Phenylcarbamoyl gelatin | 88.3 | g |
| Compound (A) (10 percent methanol solution | 10 | ml |
| Potassium bromide | 0.32 | g |
| Water to make | 5429 | ml |
| Solution (B1) | | |
| 0.67 mol/l aqueous silver nitrate solution | 2635 | ml |
| Solution (C1) | | |
| Potassium bromide | 51.55 | g |
| Potassium iodide | 1.47 | g |
| Water to make | 660 | ml |
| Solution (D1) | | |
| Potassium bromide | 154.9 | g |
| Potassium iodide | 4.41 | g |
| Iridium chloride (1 percent solution) | 0.93 | ml |
| Water to make | 1982 | ml |
| Solution (E1) | | |
| 0.4 mol/l aqueous potassium bromide solution | | |
| at an amount necessary to adjust the silver | | |
| potential to the value described below | | |
| Solution (F1) | | |
| Potassium hydroxide | 0.71 | g |
| Water to make | 20 | ml |
| Solution (G1) | | |
| 56 percent aqueous acetic acid solution | 18.0 | ml |
| Solution (H1) | | |
| Anhydrous sodium carbonate | 1.72 | g |
| Water to make | 151 | ml |
| Compound (A) | | |
| HO(CH₂CH₂O)ₙ—(CH(CH₃)CH₂O)₁₇—(CH₂CH₂O)ₘH | | |
| (wherein m + n = 5 to 7) | | |

Using an agitator described in Japanese Patent Application Publication Nos. 58-58288 and 58-58289, ¼ of Solution (B1) and the total amount of Solution (C1) were added to Solution (A1) using a double jet method over 4 minutes 45 seconds to form nuclei, while maintaining the temperature at 45° C. and pAg at 8.09. After one minute, the total amount of Solution (F1) was added thereto. During such addition, the pAg was suitably adjusted to the specified value, employing Solution (E1). After 6 minutes, ¾ of Solution (B1) and the total amount of Solution (D1) were further added according to a double jet method over 14 minutes 15 seconds, while maintaining the temperature at 450 C and pAg at 8.09.

After stirring for 5 minutes, the resulting mixture was cooled to 40° C. and subsequently the total amount of Solution (G1) was added thereto to coagulate the resulting silver halide emulsion. Leaving 2,000 ml of the resulting coagulum, the supernatant was removed, and subsequently 10 liters of water were added. After stirring, the silver halide emulsion was again coagulated. Leaving 1,500 ml of the resulting coagulum, the supernatant was removed and subsequently 10 liters of water were added. After stirring, the silver halide emulsion was again coagulated. Leaving 1,500 ml of the resulting coagulum, the supernatant was removed and subsequently Solution (H1) was added. The resulting mixture was heated to 60° C. and stirred for an additional 120 minutes. Finally, the pH was adjusted to 5.8 and water was added so that the weight per mol of silver was 1,161 g, whereby Light-Sensitive Silver Halide Emulsion A was prepared.

It was found that the resulting emulsion was comprised of monodispersed silver iodobromide cubic grains having an average grain size of 0.058 μm, a variation coefficient of grain size of 12 percent and a (100) face proportion of 92 percent.

(Preparation of Powdery Organic Silver Salt A)

Dissolved in 4,720 ml of pure water were 130.8 g of behenic acid, 67.7 g of arachidic acid, 43.6 g of stearic acid, and 2.3 g of palmitic acid at 80° C. After adding 540.2 ml of a 1.5M aqueous sodium hydroxide solution while stirring and further adding 6.9 ml of concentrated nitric acid, the resulting mixture was cooled to a temperature of 55° C. to obtain an aliphatic acid sodium salt solution. While maintaining the aforesaid aliphatic acid sodium salt solution at 55° C., 45.3 g of aforesaid Light-Sensitive Silver Halide Emulsion A and 450 ml of pure water were added, and the resulting mixture was stirred for 5 minutes.

Subsequently, 702.6 ml of 1M aqueous silver nitrate solution was added over two 2 minutes to obtain an organic silver salt dispersion. Thereafter, the resulting organic silver salt dispersion was placed in a washing vessel. While stirring, deionized water was added, and the resulting mixture was allowed to stand so that separation was carried by allowing the organic silver salt dispersion to float up and water-soluble salts remaining in the lower portion were removed. Thereafter, washing with deionized water and filtration were repeated until the filtrate reached a conductivity of 2 μS/cm. After conducting centrifugal dehydration, the obtained cake-like organic silver salt was dried under an atmosphere of inert gas according to the operation condition until the hot air temperature at the inlet of the dryer until reached a moisture content of 0.1 percent, whereby dried Powdery Organic Silver Salt A was obtained.

The moisture content of organic silver salt compositions was measured employing an infrared ray moisture meter.

(Preparation of Preliminary Dispersion A)

Dissolved in 1,457 g of methyl ethyl ketone was 14.57 g of polyvinyl butyral powder (Butvar B-79, manufactured by Monsanto Corp.). While stirring employing Dissolver Dispermat Type CA-40M, manufactured by VMA-Getzmann Co., 500 g of powdery Organic silver Salt A was added and sufficiently mixed, whereby Preliminary Dispersion A was prepared.

(Preparation of Light-Sensitive Emulsion Dispersion 1)

Preliminary Dispersion A was supplied to a media type homogenizer, Dispermat SL-C12 (manufactured by VMA-Getzmann Co.) in which 80 percent of the interior volume is occupied by φ0.5 mm zirconia beads (Torecerum, manufactured by Toray Co.) so that its retention time in the mill was 1.5 minutes by the use of a pump and was dispersed at the mill peripheral rate of 8 m/second, whereby Light-Sensitive Emulsion Dispersion was prepared.

(Preparation of a Stabilizer Solution)

Dissolved in 4.97 g of methanol was 1.0 g of Stabilizer 1 and 0.31 g of potassium acetate, whereby a stabilizer solution was prepared.

(Preparation of Infrared Sensitizing Dye Solution A)

Under a light shielded condition, dissolved in 31.3 ml of methyl ethyl ketone were 19.2 mg of Infrared Sensitizing Dye 1, 488 g of 2-chlorobenzoic acid, 779 g of Stabilizer 2, and 365 mg of 5-methyl-2-mercaptobenzimidazole, whereby Infrared Sensitizing Dye Solution A was prepared.

(Preparation of Additive Solution “a”)

Dissolved in 110 g of methyl ethyl ketone were 27.98 g of 1,1-bis(2-hydroxy-3,5-dimethylphenyl)-2-methylpropane, 54 g of 4-methyl-phthalic acid, and 0.48 g of the aforesaid Infrared Dye 1. The resulting solution was designated as Additive Solution “a”.

(Preparation of Additive Solution “b”)

Dissolved in 40.9 g of methyl ethyl ketone were 56 g of Antifoggant 2 and 40.9 g of phthalazine. The resulting solution was designated as Additive Solution “b”.

(1) Stabilizer 1

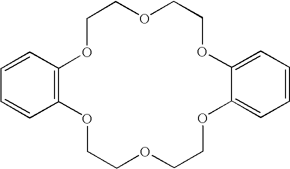

(2) Stabilizer 2

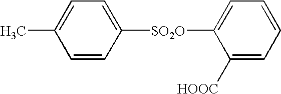

(3) Antifoggant 2

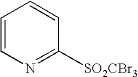

(4) Infrared Sensitizing Dye (SD-1)

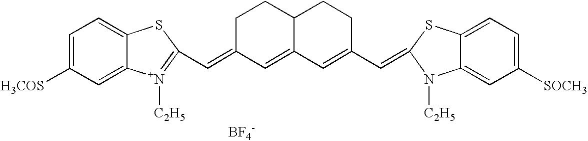

<<Preparation of Light-Sensitive Layer Coating Composition>>

While stirring, 150 g of aforesaid Light-Sensitive Emulsion Dispersion 1 and 15.11 g of methyl ethyl ketone were maintained at 21° C. Subsequently, 494 μl of a 10 percent calcium bromide methanol solution was added and the resulting mixture was stirred for 10 minutes. Subsequently, 167 ml of Stabilizer Solution was added and the resulting mixture was stirred for 10 minutes. Thereafter, 1.32 g of aforesaid Infrared Sensitizing Dye Solution A was added and the resulting mixture was stirred for one hour.

Thereafter, the resulting mixture was cooled to 13° C. and stirred for an additional 30 minutes. While maintaining the resulting composition at 13° C., 13.31 g of polyvinyl butyral (B-79, manufactured by Monsanto Corp.) was added, and the resulting mixture was stirred for 30 minutes. Thereafter, 1.084 g of a 9.4 percent by weight tetrachlorophthalic acid methyl ethyl solution was added, and the resulting mixture was stirred for 15 minutes. Under continued stirring, 12.43 g of Additive Solution “a”, 1.6 ml of a 10 percent Desmodur N3300 (aliphatic isocyanate, manufactured by Mobay Corp.) methanol solution, and 4.27 g of Additive Solution “b” were successively added, and the resulting mixture was stirred, whereby a light-sensitive layer coating composition was prepared.

Dissolved in 42.5 g of methyl ethyl ketone was 7.5 g of cellulose acetate butyrate (CAB171-15, manufactured by Eastman Chemical Co.), and subsequently 5 g of calcium carbonate (Super-Pflex 200, manufactured by Speciality Minerals Co.) was added to the resulting solution. The resulting mixture was dispersed at 8,000 rpm for 30 minutes, employing a dissolver type homogenizer, whereby a matting agent dispersion was prepared.

<<Preparation of a Surface Protective Layer Coating Composition>>

While stirring, dissolved in 865 of methyl ethyl ketone were 96 g of cellulose acetate butyrate (CAB171-15, manufactured by Eastman Chemical Co.), 4.5 g of polymethyl methacrylic acid (Pararoid A-21, manufactured by Rohm & Haas Co.), 1.5 g of Vinylsulfone Compound HD-1, 1.0 g of benztriazole, and 1.0 g of an F based surfactant (Surfron KH40, manufactured by Asahi Glass Co.). Subsequently, while stirring, 30 g of the aforesaid matting agent dispersion was added to the resulting solution, whereby a surface protective layer coating composition was prepared.

Vinylsulfone Compound HD-1: (CH₂═CHSO₂CH₂)₂CHOH

<<Preparation of Water Based Silver Salt Photothermographic

Dry Imaging Material Samples 1-24 through 1-33>>As shown in Tables 3 and 4, silver salt photothermographic dry imaging materials 1-24 through 1-33 were prepared by applying a backing layer (an antihalation layer), a light-sensitive layer, and a surface protective layer onto Subbed Samples 1-10, 1-12, and 1-13 and 1-20 through 1-26.

The antihalation layer coating composition and the back surface protective layer coating composition were subjected to simultaneous multilayer coating onto the backing sublayer of the aforesaid subbed samples and subsequently the resulting coating was dried, whereby an antihalation back layer was prepared. Coating was carried out so that the coating weight of solids of minute dye particles in the aforesaid back surface protective layer coating composition achieved 0.04 g/m², while the coating weight of gelatin in the aforesaid back surface protective coating composition achieved 1.7 g/m². Subsequently, an image forming layer (at a silver coverage of silver halide of 0.14 g/m²), an interlayer, a first protective layer and a second protective layer were subjected to simultaneous multilayer coating, in the stated order starting from the surface of the sublayer, onto the surface opposite the back surface, employing a slide bead coating system, whereby thermal developing light-sensitive material samples were prepared.

Coating was carried out at a coating rate of 160 m/minute. The space between the coating die edge and the support was adjusted to 0.14 to 0.28 mm. Further, the coating width was adjusted to be wider by 0.5 mm with respect to the discharge slit width of coating compositions at the right and left edges, while pressure in the pressure reducing chamber was set to be 392 Pa lower than atmospheric pressure. In such a way, handling as well as temperature and humidity was controlled so that supports were not electrostatically charged. Further, just prior to coating, electrostatic charge was eliminated employing ion air flow. In the following chill zone, the coating was cooled for 30 seconds employing blown air having a wet bulb temperature of 12° C. Subsequently, in a helically floating system drying zones, air flow having a dry bulb temperature of 30° C. and a wet bulb temperature of 18° C., the coating was blown for 200 seconds. Thereafter, the resulting coating passed through a 70° C. drying zone for 20 seconds and then passed through a 90° C. drying zone for 10 seconds. The coating was then cooled to 25° C. and solvents in the coating compositions were evaporated. The rate of air flow which was blown onto the surface of the coating was 7 m/second. The degree of matte of the prepared thermal developing materials was 550 seconds for the surface of the image layer side and 130 seconds for the back surface. The degree of matte is expressed in terms of Beck smoothness.

<<Preparation of an Antihalation Layer Coating Composition>>

(1) Preparation of Minute Basic Precursor Solid Particle Dispersion

Mixed with 220 ml of distilled water were 64 g of Basic Precursor Compound 11, 28 g of diphenylsulfone, and 10 g of surfactant Demol N, manufactured by Kao Corp. The resulting mixture was subjected to bead dispersion employing a sand mill (¼ gallon Sand Grinder Mill, manufactured by Imex Co.), whereby Minute Precursor Compound Solid Particle Dispersion (a) having an average particle diameter of 0.2 μm was prepared.

(2) Preparation of a Minute Dye Solid Particle Dispersion

Mixed with 305 ml of distilled water were 9.6 g of Cyanine Dye Compound 13 and 5.8 g of sodium p-dodecylbenzenesulfonate. The resulting mixture was subjected to bead dispersion employing a sand mill (¼ gallon Sand Grinder Mill, manufactured by Imex Co.), whereby a minute precursor compound solid particle dispersion having an average particle diameter of 0.2 μm was prepared.

(Preparation of an Antihalation Layer Coating Composition)

Mixed with 844 ml of water were 17 g of gelatin, 9.6 g of polyacrylamide, 70 g of aforesaid Minute Basic Precursor Solid Particle Dispersion, 56 g of aforesaid minute dye solid particle dispersion, minute polymethyl methacrylate particles (having an average particle size of 6.5 μm), 0.03 g of benzoisothiazolinone, 2.2 g of sodium polyethylenesulfonate, and 0.2 g of Blue Dye Compound 14. Thus an antihalation layer coating composition was prepared.

<<Preparation of a Back Surface Protective Layer Coating Composition>>

In a vessel maintained at 40° mixed were 50 g of gelatin, 0.2 g of sodium polystyrenesulfonate, 2.4 g of N,N-ethylenebis(vinylsulfonamido), 1 g of sodium t-octylphenoxyethoxyethanesulfonate, 30 mg of benzoisothiazolinone, 37 mg of N-perfluorooctylsulfonyl-N-propylalanine potassium salt, 0.15 g of polyethylene glycol mono(N-perfluorooctylsulfonyl-N-propyl-2-aminoethyl) ether (having an average degree of polymerization of ethylene oxide of 15), 32 mg of C₈F₁₇SO₃K, 64 mg of C₈F₁₇SO₂N(C3H7) (CH2CH2O) 4-SO₃Na, 8.8 g of acrylic acid/ethyl acrylate copolymer (having a copolymer weight ratio of 5/95), 0.6 g of Aerosol OT (manufactured by American Cyanamid Co.), 1.8 g of liquid paraffin emulsion as liquid paraffin, and 950 ml of water, whereby a back surface protective layer coating composition was prepared.

<<Preparation of Silver Halide Emulsion 1>>

Added to 1,421 ml of distilled water was 8.0 ml of a 1 weight percent potassium bromide solution, and further 8.2 ml of 1 mol/liter nitric acid and 20 g of phthalated gelatin. While stirring, the resulting mixture was maintained at 37° C. in a stainless steel reaction vessel. On the other hand, Solution A was prepared in such a manner that distilled water was added to 37.04 g of silver nitrate and the total volume was adjusted to 159 ml. Solution B was also prepared in such a manner that water was added to 32.6 g of potassium bromide and the total volume was adjusted to 200 ml. Subsequently, all of Solution A was added to the aforesaid solution under a constant flow rate over one minute according to a controlled double-jet method while maintaining the pAg at 8.1.

Solution B was also added according to the controlled double-jet method. Thereafter, a 30 ml of a 3.5 weight percent aqueous hydrogen peroxide solution was added, and subsequently 36 ml of a 3 weight percent aqueous benzimidazole solution was added. Thereafter, Solution A2 was also prepared by diluting Solution A employing distilled water for a total volume of 317.5 ml. On the other hand, trisodium hexachloroiridate was dissolved in Solution B to obtain a concentration of 1×10⁻⁴ mol per mol of silver. Subsequently Solution B2 was prepared by diluting the aforesaid solution with distilled water for a total volume of 400 ml which was double compared to Solution B. Thereafter, all Solution A2 was added to the resulting mixture under a constant flow rate over ten minutes according to a controlled double-jet method while maintaining the pAg at 8.1. B2 was also added according to the controlled double-jet method. Thereafter, 50 ml of a 5 weight percent 5-methyl-2-pmercaptobenzimidazole methanol solution was added. Subsequently, pAg was increased to 7.5, employing silver nitrate and then the pH was adjusted to 3.8 by adding 1 mol/liter sulfuric acid. Thereafter, stirring was terminated, and coagulation/desalting/washing processes were carried out followed by addition of 3.5 g of deionized gelatin. Finally, by adding 1 mol/liter sodium hydroxide, the pH and pAg were adjusted to 6.0 and 8.2, respectively, whereby a silver halide dispersion was prepared.

Grains of the finished silver halide emulsion were pure silver bromide grains having an average sphere equivalent diameter of 0.053 μm and a variation coefficient of sphere equivalent diameter of 18 percent. The grain size was determined as follows. By employing an electron microscope, the diameter of 1,000 grains were determined, and the average was then obtained. The ratio of (100) face of grains was obtained employing the Kubelka-Munk method, by which the ratio was found to be 85 percent.

While stirring, added to the aforesaid emulsion maintained at 38° C. was 0.035 g (in the form of 3.5 weight percent methanol solution) of benzoisothiazolinone. After 40 minutes, a spectral sensitizer solid dispersion (an aqueous gelatin solution) was added in an amount of 5×10⁻³ mol per mol of silver. After one minute, the resulting mixture was heated to 47° C., and 20 minutes later, sodium benzenethiosulfonate was added in an amount of 3×10⁻⁵ mol per mol of silver. After further 2 minutes, tellurium sensitizers were added in an amount of 5×10⁻⁵ Mol per mol of silver. The resulting mixture underwent ripening for 90 minutes. At nearly complete ripening, 5 ml of a 5 percent N,N-hydroxy-N-diethylmelamine methanol solution was added. The resulting mixture was cooled to 31° C. and 5 weight percent phenoxyethanol methanol solution, 5-methyl-2-mercaptobenzimidazole in an amount of 7×10⁻³ per mol of silver, and 1-phenyl-2-heptyl-5-mercapto-1,3,4-triazole in an amount of 6.4×10⁻³ were added, whereby Silver Halide Emulsion 1 was prepared.

<<Preparation of Silver Halide Emulsion 2>>

A pure silver bromide cubic grain emulsion, having an average sphere equivalent diameter of 0.08 μm and a variation coefficient of the sphere equivalent diameter of 15 percent, was prepared in the same manner as Silver Halide Emulsion 1, except that the temperature of the solution during grain formation was changed from 37° C. to 50° C. Coagulation/desalting/washing/dispersion was carried out in the same manner as for Silver Halide Emulsion 1. Further, Silver Halide Emulsion 2 was prepared in the same manner as for Silver Halide Emulsion 1 with respect to the spectral sensitization, chemical sensitization and addition of 5-methyl-2-mercaptobenzimidazole and 1-phenyl-2-heptyl-5-mercapto-1,3,4-triazole, except that the added amount of the spectral sensitizing dye was changed to 4.5×10⁻³ mol per mol of silver.

<<Preparation of Silver Halide Emulsion 3>>

A pure silver bromide cubic grain emulsion, having an average sphere equivalent diameter of 0.038 μm and a variation of the sphere equivalent diameter of 20 percent, was prepared in the same manner as silver Halide Emulsion 1, except that the temperature during grain formation was changed from 37° C. to 27° C. The resulting emulsion was subjected to coagulation/desalting/washing/dispersion in the same manner as Silver Halide Emulsion 1. Further, Silver Halide Emulsion 3 was prepared in the same manner as for Silver Halide Emulsion 1 with respect to spectral sensitization, chemical sensitization and addition of 5-methyl-2-mercaptobenzimidazole and 1-phenyl-2-heptyl-5-mercapto-1,3,4-triazole, except that the added amount of the spectral sensitizing dye was changed to 6×10⁻³ mol per mol of silver.

<<Preparation of Mixed Emulsion A Coating Composition>>

A mixed emulsion was prepared by mixing 70 percent by weight of Silver Halide Emulsion 1, 15 percent by weight of Silver Halide Emulsion 2, and 15 percent by weight of Silver Halide Emulsion 3. Added to the resulting mixed emulsion was benzothiazolium iodide in the form of a 1 percent aqueous solution in an amount of 7×10⁻³ per mol of silver.

<<Preparation of a Scaly Fatty Acid Silver Salt>>

A mixture consisting of 87.6 g of behenic acid, (trade name; Edenor C22-85R, manufactured by Henkel Corp.), 423 ml of distilled water, 49.2 ml of a 5 mol/L aqueous NaOH solution, and 120 ml of tert-butanol underwent reaction while stirring at 75° C. for one hour, whereby a sodium behenate solution was prepared. Separately, 206.2 ml (having a pH of 4.0) of an aqueous solution containing 40.4 g of silver nitrate was prepared and maintained at 10° C. A reaction vessel, in which 635 ml of distilled water and 30 ml of tert-butanol were placed, was maintained at 30° C. While stirring, the total amount of the sodium behenate solution prepared as above and the total amount of the aqueous silver nitrate solution prepared as above were added at a constant flow rate over 62 minutes 10 seconds and 60 minutes, respectively. During the initial 7 minutes 20 seconds, only the aqueous silver nitrate solution was added. Thereafter, the sodium behenate solution was added. Nine minutes 30 seconds after the addition of the aqueous silver nitrate solution, only the sodium behenate solution was added.

During these operations, the interior temperature of the reaction vessel was set at 30° C. and the exterior temperature was controlled so that the reaction composition was maintained at a definite temperature. Further, the temperature of the piping, which was employed to add the sodium behenate solution, was maintained employing steam tracing, and the steam aperture was adjusted so that the composition temperature at the leading edge of the addition nozzle was 75° C. Further, the temperature of was maintained by circulating chilled water in the exterior side of a double pipe. The addition position of the sodium behenate and the addition position of the aqueous silver nitrate solution were arranged to be symmetrical while the stirring shaft was positioned at the center. Further the height was adjusted so that the reaction composition was not brought in contact with the reaction composition. After adding the sodium behenate solution, the resulting mixture was stirred for 20 minutes at the same temperature and then cooled to 25° C. Thereafter, solids were collected by suction filtration. The resulting solids were washed with water until the conductivity of filtered water reached 30 μS/cm. Thus, a fatty acid silver salt was obtained. The obtained solids were not dried but stored in the form of a wet cake.

The obtained silver behenate particles were photographed employing an electron microscope and then evaluated. It was found that the aforesaid particles were comprised of scaly crystals having a=0.14 μm, b=0.4 μm, c=0.6 μm (a, b, and c are specified in the present description) as an average value, an average aspect ratio of 5.1, an average sphere equivalent diameter of 0.52 μm, and a variation coefficient of the sphere equivalent diameter of 15 percent. Added to the wet cakes equivalent to 100 g of dried solids were 7.4 g of polyvinyl alcohol (trade name: PVA-217, having an average degree of polymerization of 1,700). Thereafter the total volume was adjusted to 385 g by adding water. The resulting mixture was preliminarily dispersed employing a homomixer. Subsequently, the preliminarily dispersed composition was dispersed three times, while adjusting the pressure to 1,750 kg/cm² employing a homogenizer (trade name: Microfluidizer M-110s-EH, manufactured by Microfluidics International Corporation, a GLOZ Interaction Chamber was used), whereby a silver behenate dispersion was obtained. A cooling operation was carried out as follows. A coiled type heat exchanger was provided prior to and after the interaction chamber and the dispersion temperature was set at 18° C. by adjusting the temperature of the refrigerant.

<<Preparation of a 25 Weight Percent Reducing Agent Dispersion>>

Added to 10 kg of 1,1-bis(2-hydroxy-3,5-dimethylphenyl)-3,5,5-trimethylhexane and 10 kg of a 20 weight percent aqueous modified polyvinyl alcohol (Poval MP203, manufactured by Kuraray Co.) solution was 16 kg of water. The resulting mixture was well stirred to form a slurry. The resulting slurry was conveyed by a diaphragm pump and was dispersed for 3 hours 30 minutes employing a horizontal type sand mill (UVM-2, manufactured by Imex Co.) filled with an average diameter 0.5 mm zirconia beads. Thereafter, water and 0.2 g of benzoisothiazolinone sodium salt were added so as to obtain the concentration of the reducing agent to be 25 percent by weight, whereby a reducing agent dispersion was prepared. The reducing agent particles comprised in the reducing agent dispersion prepared as above had a median diameter of 0.40 μm and a maximum particle diameter of at most 1.8 μm. The prepared reducing agent dispersion was filtered employing a pore diameter 10.0 μm polypropylene filter, whereby foreign matter such as dust was removed and then stored.

<<Preparation of a 10 Weight Percent Mercapto Compound Dispersion>>

Added to 5 kg of 1-phenyl-2-heptyl-5-mercapto-1,3,4-triazole and 5 kg of a 20 weight percent aqueous polyvinyl alcohol (Poval MP203, manufactured by Kuraray Co.) solution was 8.3 kg of water. The resulting mixture was well stirred to prepare a slurry.

The resulting slurry was conveyed employing a diaphragm pump and subsequently dispersed for 6 hours, employing a horizontal type sand mill (UVM-2, manufactured by Imex Co.) filled with an average diameter 0.5 mm zirconia beads. Thereafter, water was added so that the concentration of the mercapto compound became 10 percent by weight, whereby a mercapto dispersion was prepared. The median diameter of mercapto compound particles incorporated in the mercapto compound dispersion, prepared as above, was 0.40 μm, while the maximum particle size thereof was at most 2.0 μm. The obtained mercapto compound dispersion was filtered employing a 10.0 μm pore diameter polypropylene filter. Further, just prior to use, filtration was carried out employing a 10 μm pore diameter polypropylene filter.

<<Preparation of 20 Weight Percent Organic Polyhalogen Compound Containing Dispersion 1>>

Five kg of tribromomethylnaphthylsulfone, 2.5 kg of a 20 weight percent aqueous modified polyvinyl alcohol (Poval M203, manufactured by Kuraray Co.) solution, 213 g of 20 weight percent aqueous sodium triisopropylnaphthalenesufonate solution, and 10 kg of water were well mixed to form a slurry. The resulting slurry was conveyed employing a diaphragm pump and was dispersed for 5 hours employing a horizontal type sand mill (UVM-2, manufactured by Imex Co.) which was filled with average diameter 0.5 mm zirconia beads. Thereafter, 0.2 g of benzoisothiazolinone sodium salt and water were added so that the concentration of the polyhalogen compound resulted in 20 percent by weight, whereby an organic polyhalogen dispersion was obtained. The median diameter and the maximum diameter of polyhalogen compound particles incorporated in the polyhalogen dispersion, prepared as above, were 0.36 μm and at most 2.0 μm, respectively. The obtained organic polyhalogen compound dispersion was filtered employing a 3.0 μm pore diameter propylene filter to remove foreign matter such as dust, and the resulting dispersion was stored.

<<Preparation of 25 Weight Percent Organic Polyhalogen Compound Containing Dispersion 2>>

In the same manner as Preparation of 20 Weight Percent Organic Polyhalogen Compound Containing Dispersion 1, dispersion was carried out, except that 5 kg of tribromonaphthylsulfone was replaced with 5 kg of N-butyl-3-tribromomethanesulfonylbenzamide. Subsequently dilution was carried out so that the concentration of the aforesaid organic polyhalogen compound resulted in 25 percent by weight, and the resulting dispersion was filtered. The median diameter and the maximum diameter of polyhalogen compound particles incorporated in the polyhalogen dispersion, prepared as above, were 0.39 μm and at most 2.2 μm, respectively. The obtained organic polyhalogen compound dispersion was filtered employing a 3.0 μm pore diameter propylene filter to remove foreign matter such as dust and the resulting dispersion was stored.

<<Preparation of 30 Weight Percent Organic Polyhalogen Compound Containing Dispersion 3>>

In the same manner as preparation of 20 Weight Percent Organic Polyhalogen Compound Containing Dispersion 1, dispersion was carried out except that 5 kg of tribromomethylnaphthylsulfone was replaced by 5 kg of tribromomethylphenylsulfone, and 5 kg of a 20 weight percent aqueous MP203 solution was employed. Subsequently dilution was carried out so that the concentration of the aforesaid organic polyhalogen compound resulted in 30 percent by weight, and the resulting dispersion was filtered. The median diameter and the maximum diameter of polyhalogen compound particles incorporated in the polyhalogen dispersion, prepared as above, were 0.41 μm and at most 2.0 μm, respectively. The obtained organic polyhalogen compound dispersion was filtered employing a 3.0 μm pore diameter propylene filter to remove foreign matter such as dust and the resulting dispersion was stored. Further, the resulting dispersion was stored at less than or equal to 10° C. until its use.

<<Preparation of 5 Weight Percent Phthalazine Compound Solution>>

Dissolved in 174.57 kg of water was 8 kg of modified polyvinyl alcohol MP203, manufactured by Kuraray Co. Subsequently 3.15 kg of a 20 weight percent aqueous sodium triisopropylnaphthalenesulfonate solution, and 14.28 kg of a 70 weight percent aqueous 6-isopropylphthalazine solution were added, whereby a 5 weight percent 6-isopropylphthalazine solution was prepared.

<<Preparation of a 20 Weight Percent Pigment Dispersion>>

Added to 250 g of water were 64 g of C.I. Pigment Blue 60 and 6.4 g of Demol N, manufactured by Kao Corp., and the resulting mixture was well stirred to form a slurry. The prepared slurry was charged into a vessel together with 800 g of average diameter 0.5 mm zirconia beads. The resulting mixture was dispersed for 25 hours employing a homogenizer (1/4G Sand Grinder Mill manufactured by Imex Co.), whereby a pigment dispersion was prepared. The average diameter of the pigment particles incorporated in the pigment dispersion, prepared as above, was 0.21 μm.

<<Preparation of a 40 Weight Percent SBR Latex>>

SBR latex purified employing ultrafiltration (UF) was prepared as follows. The SBR latex described below was diluted by a factor of 10 with distilled water. The diluted SBR latex was subjected to dilution purification employing a UF-purification module FS03-FC-FUY03A1 (manufactured by Daisen-Membrane-System Co.) until the ionic conductivity reached 1.5 mS/cm, and Sundet-BL was then added to obtain 0.22 percent by weight. Further, NaOH and NH₄OH were added to achieve Na⁺ ion: NH₄ ion=1:2.3 (in mol ratio) and the pH was adjusted to 8.4. In this case, latex concentration was 40 percent by weight.

SBR latex: (latex of -St(68)—Bu(29)-AA(3)-) having an average particle diameter of 0.1 μm, a concentration of 45 percent, an equilibrium water content ratio of 0.6 percent by weight at 25° C. and 60 percent relative humidity, and an ionic conductivity of 4.2 mS/cm (the original latex (40 percent) was measured at 25° C., employing a conductivity meter CM-30S, manufactured by DKK-TOA Corp.). Further, the pH was 8.2.

<<Preparation of an Image Forming Layer Coating Composition>>

An image forming layer (a light-sensitive layer or an emulsion layer) coating composition was prepared by thoroughly mixing 1.1 g of the 20 weight percent aqueous pigment dispersion prepared as above, 103 g of the organic acid silver dispersion, a 20 percent aqueous polyvinyl alcohol PVA-205 (manufactured by Kuraray Co.) solution, 25 g of the aforesaid 25 weight percent reducing agent dispersion, 13.2 g of Organic Polyhalogen Compounds 1, 2, and 3 at a ratio of 2:5:2 (in terms of weight ratio), 6.2 g of a 10 percent mercapto compound dispersion, 106 g of a 40 weight percent pH adjusted SBR latex which had been purified employing ultrafiltration (UF) 18 ml of a 5 weight percent phthalazine solution and 10 g of mixed silver halide emulsion A. The resulting coating composition was conveyed to a coating die without any modification to achieve a coating of 70 ml/m².

The viscosity of the aforesaid image forming layer coating composition was measured at 40° C. (No. 1 Roter, 60 rpm) employing a B Type Viscosimeter manufactured by Tokyo Keiki, resulting in 85 mPa·s. The viscosity of the coating compositions was also measured at 25° C., employing an RFS Fluid Spectrometer, manufactured by Reometric Far-East Co. and the viscosity at a shearing rate of 0.1, 1, 10, 100, and 1,000 (1/second) was 1,500, 220, 70, 40, and 20 mPa·s, respectively.

<<Preparation of an Emulsion Surface Interlayer Coating Composition>>

An interlayer coating composition was prepared in such a way that 772 g of a 10 weight percent aqueous polyvinyl alcohol PVA-205 (manufactured by Kuraray Co.) solution, 5.3 g of a 20 weight percent pigment dispersion, 226 g of a 27.5 weight percent methyl methacrylate/styrene/butyl acrylate/hydroxyethyl methacrylate/acrylic acid copolymer (having a copolymerization weight ratio of 64/9/20/5/2) latex, 2 ml of a 5 weight percent Aerosol OT (manufactured by American Cyanamid Co.) were mixed and the total weight was adjusted to 880 g by adding water. The resulting coating composition was conveyed to a coating die so as to result in 10 ml/m². The viscosity of the coating composition was measured at 40° C., employing a B Type Viscosimeter (No. 1 Roter, 60 rpm), resulting in 21 mPa·s.

<<Preparation of Emulsion Surface Protective Layer First Layer Coating Composition>>

This coating composition was prepared in such a manner that 80 g of a 27.5 weight percent methyl methacrylate/styrene/butyl acrylate/hydroxyethyl methacrylate/acrylic acid copolymer (copolymerization weight ratio of 64/9/20/5/2) latex, 23 ml of a 10 weight percent phthalic acid methanol solution, 23 ml of a 10 weight percent aqueous 4-methylphthalic acid solution, 28 ml of a 1 mol/L sulfuric acid, 5 ml of a 5 weight percent aqueous Aerosol OT (manufactured by American Cyanamid Co.) solution, 0.5 g of phenoxyethanol, and 0.1 g of benzoisothiazolinone were added to a gelatin solution prepared by dissolving 64 g of gelatin in water, and the total weight was adjusted to 750 g with water. Just prior to coating, 26 ml of a 4 weight percent chromium alum solution was added. The resulting coating composition was conveyed to a coating die to achieve 18.6 ml/m². The viscosity of the coating composition was measured at 40° C., employing a B Type Viscosimeter (No. 1 Roter, 60 rpm), resulting in 17 mPa·s.

<<Preparation of an Emulsion Surface Protective Layer Second Layer Coating Composition>>

A coating composition was prepared in such a way that 80 g of inert gelatin was dissolved in water; 102 g of a 27.5 weight percent methyl methacrylate/styrene/butyl acrylate/hydroxyethyl methacrylate/acrylic acid copolymer (copolymerization weight ratio of 64/9/20/5/2) latex, 3.2 ml of a 5 weight percent N-perfluoroctylsulfonyi-N-propylalanine potassium salt solution, 32 ml of a 2 weight percent aqueous polyethylene glycol mono(N-perfluoroctylsulfonyl-N-propyl-2-aminoethyl)ether (the average degree of polymerization of the ethylene oxide of this compound was 15) solution, 23 ml of a 5 weight percent Aerosol OT (manufactured by American Cyanamid Co.) solution, 4 g of minute polymethyl methacrylate particles (having an average particle diameter of 0.7 μm), 21 g of minute polymethyl methacrylate particles (having an average particle diameter of 6.4 μm), 1.6 g of 4-methylphthalic acid, 4.8 g of phthalic acid, 44 ml of 1 mol/L sulfuric acid, and 10 mg of benzoisothiazolinone were added to a gelatin solution prepared by dissolving 80 g of inert gelatin in water, and the total weight was adjusted to 650 g by adding water. Just prior to coating, 445 ml of an aqueous solution containing 4 weight percent chromium alum and 0.67 weight percent of phthalic acid was added to prepare a surface protective layer coating composition which was conveyed to a coating die to achieve 8.3 ml/m². The viscosity of the resulting coating composition was measured at 40° C. employing a B Type Viscosimeter (No. 1 Roter, 60 rpm), resulting in 9 mPa·s. (Evaluation of Characteristics) Evaluation methods are described below.

<<Adhesion Properties of Light-Sensitive Layer Surface Immediately After Development>>

Samples were thermally developed at 123° C. for 15 seconds, employing an automatic processor comprising a heating drum. Almost immediately (45 to 60 seconds) after development, employing a razor, the surface of the resulting sample was cut at an angle of 45 degrees with respect to the sample surface. Self-adhesive cellophane tape was then brought into pressure contact with the sample surface across the cut. Subsequently, the resulting tape was rapidly peeled off in a nearly horizontal direction opposite the 45 degrees and any peeled area of the heat-developing image forming layer was measured and evaluated according to the evaluation standards listed below.

1. Adhesion force was very low and the heat developing image forming layer was completely peeled off

2. The peeled area was between 50 and 100 percent

3. The peeled area was between 20 and 50 percent (a minimally acceptable level for commercial viability)

4. Adhesion force was high and the peeled area was between 5 and 20 percent

5. Adhesion force was very high and the peeled are was less than 5 percent

<<Abrasion Resistance immediately after Development>>

Samples were thermally developed at 123° C. for 15 seconds, employing an automatic processor comprising a heating drum. Almost immediately (45 to 60 seconds) after development, the resulting samples were tested as follows. In the same manner as the test method specified in JIS K 5400, the sample surface was written on in pencil at an angle of 45 degrees with respect to the sample surface and the resulting breakage of the image forming layer was evaluated as a pencil scratch value according to the method described in JIS K 5400. Evaluation standard was based on 9H, 8H, 7H, 6H, 5H, 4H, 3H, 2H, H, F, HB, B, 2B, 3B, 4B, 5B, 6B in the order of hardness. It was determined that a pencil scratch value of 2H or higher resulted in no problems for practical use and F was the minimal acceptable level.

<<Uneven Development>>

Each of the prepared silver salt photothermographic dry imaging material samples was uniformly exposed to result in a density of 1.0, and subsequently thermally developed at 123° C. for 15 seconds, employing an automatic heat developing processor. Coatability of each sample was visually evaluated under the following standards.

1: definite unevenness was noticed

2: slight unevenness was noticed

3: minute unevenness was noticed

4: unevenness was hardly noticed

5: uniformity with no unevenness was noticed

TABLE 5

| Photographic | Subbed | | | | |
|---|---|---|---|---|---|
| Material | Sample | | | Uneven | |
| Sample No. | No. | *2 | *3 | Development | Remarks |
| 1-1 | 1-1 | 3 | F | 3 | Inv. |
| 1-2 | 1-2 | 3 | F | 3 | Inv. |
| 1-3 | 1-3 | 3 | F | 3 | Inv. |
| 1-2 | 1-2 | 5 | 4H | 5 | Inv. |
| 1-4 | 1-4 | 5 | 4H | 5 | Inv. |
| 1-5 | 1-5 | 5 | 4H | 5 | Inv. |
| 1-6 | 1-6 | 5 | 4H | 5 | Inv. |
| 1-7 | 1-7 | 5 | 4H | 5 | Inv. |
| 1-8 | 1-8 | 5 | 4H | 5 | Inv. |
| 1-9 | 1-9 | 2 | HB | 2 | Comp. |
| 1-35 | 1-32 | 4 | 2H | 4 | Inv. |
| 1-36 | 1-33 | 5 | 4H | 5 | Inv. |
| 1-10 | 1-10 | 2 | HB | 2 | Comp. |
| 1-11 | 1-27 | 4 | 2H | 5 | Inv. |
| 1-12 | 1-28 | 4 | 2H | 5 | Inv. |
| 1-13 | 1-29 | 4 | 2H | 5 | Inv. |
| 1-14 | 1-30 | 3 | HB | 2 | Comp. |
| 1-15 | 1-11 | 2 | HB | 2 | Comp. |
| 1-16 | 1-12 | 2 | HB | 2 | Comp. |
| 1-17 | 1-13 | 4 | 2H | 4 | Inv. |
| 1-18 | 1-14 | 5 | 3H | 5 | Inv. |
| 1-19 | 1-15 | 5 | 3H | 5 | Inv. |
| 1-20 | 1-16 | 5 | 3H | 5 | Inv. |
| 1-21 | 1-17 | 5 | 3H | 5 | Inv. |
| 1-22 | 1-18 | 5 | 3H | 5 | Inv. |
| 1-23 | 1-19 | 2 | B | 2 | Comp. |
| 1-37 | 1-34 | 5 | 4H | 5 | Inv. |
| 1-24 | 1-10 | 2 | HB | 2 | Comp. |
| 1-25 | 1-20 | 2 | HB | 2 | Comp. |
| 1-26 | 1-12 | 2 | HB | 2 | Comp. |
| 1-27 | 1-13 | 4 | 2H | 4 | Inv. |
| 1-28 | 1-21 | 5 | 3H | 5 | Inv. |
| 1-29 | 1-22 | 5 | 3H | 5 | Inv. |
| 1-30 | 1-23 | 5 | 3H | 5 | Inv. |
| 1-31 | 1-24 | 5 | 3H | 5 | Inv. |
| 1-32 | 1-25 | 5 | 3H | 5 | Inv. |
| 1-33 | 1-26 | 2 | B | 2 | Comp. |
| 1-34 | 1-31 | 2 | B | 2 | Comp. |
| 1-38 | 1-34 | 5 | 4H | 5 | Inv. |

*2; Adhesion Property immediately after Development
*3; Abrasion Resistance immediately after Development
Inv.; Present Invention
Comp.; Comparative Sample

As can clearly be seen from Table 7, silver salt photothermographic dry imaging material samples (photographic material samples), employing the subbed sample according to the present invention, resulted in minimal peeling of the image forming layer from the support as well minimal abrasion immediately after thermal development, and also exhibited minimal uneven development, compared to the comparative samples.

### Example 2

Subbed Samples 2-1 through 2-5 were prepared in the same manner as Subbed Sample 1-1, except that the binder which constituted Upper Subbed Layer A-2 on the light-sensitive later side was varied as shown in Table 6.

Further, Subbed Samples 2-6 through 2-8 were prepared in such a manner that without coating a subbed layer, as shown in Table 6, Upper Subbed Layer A-2 was applied onto the surface which had been subjected to a direct corona discharge treatment.

<<Preparation of Solvent Based Silver Salt Photothermographic Dry Imaging Material Samples 2-1 through 2-9>>

As shown in Table 6, Silver Salt Photothermographic Dry Imaging Material Samples 2-1 through 2-9 were prepared in the same manner as Example 1 by providing Subbed Samples 2-1 through 2-8 and 1-20 with the backing layer, the light-sensitive layer, and the surface protective layer.

<<Preparation of Water Based Silver Salt Photothermographic Dry Imaging Material Samples 2-10 through 2-12>>

As shown in Table 6, Silver Salt Photothermographic Dry Imaging Material Samples 2-10 through 2-12 were prepared in the same manner as Example 1 by providing Subbed Samples 2-6 through 2-8 with the backing layer, the light-sensitive layer, and the surface protective layer.

TABLE 6

| | | Light-Sensitive Layer Side | | | | | | | | |
|---|---|---|---|---|---|---|---|---|---|---|
| | | | Upper Sublayer | | | | | | | |
| Photo- | | Presence | | Vinyl | | | | | | |
| graphic | | or | | Modification | Dried | | | | | |
| material | Subbed | Absence | Binder | Ratio | Layer | | | | | |
| Sample | Sample | of Lower | Poly- | Weight | Thickness | Coating | | | | |
| No. | No. | Layer | ester | Percent | μm | Composition | *1 | *2 | *3 | Remarks |
| 1-1 | 1-1 | presence | A-1 | 0 | 0.2 | solvent based | 3 | F | 3 | Inv. |
| 2-1 | 2-1 | presence | B-1 | 20 | 0.2 | solvent based | 5 | 4H | 5 | Inv. |
| 2-2 | 2-2 | presence | B-2 | 20 | 0.2 | solvent based | 5 | 4H | 5 | Inv. |
| 2-3 | 2-3 | presence | B-3 | 20 | 0.2 | solvent based | 5 | 4H | 5 | Inv. |
| 2-4 | 2-4 | presence | B-4 | 8 | 0.2 | solvent based | 5 | 2H | 5 | Inv. |
| 2-5 | 2-5 | presence | B-5 | 12 | 0.2 | solvent based | 5 | 4H | 5 | Inv. |
| 1-10 | 1-10 | absence | A-1 | 0 | 0.2 | solvent based | 2 | HB | 2 | Comp. |
| 2-6 | 1-20 | absence | A-3 | 0 | 0.2 | solvent based | 2 | HB | 2 | Comp. |
| 1-16 | 1-12 | absence | A-4 | 0 | 0.2 | solvent based | 2 | HB | 2 | Comp. |
| 2-7 | 2-6 | absence | B-1 | 20 | 0.2 | solvent based | 5 | 3H | 5 | Inv. |
| 2-8 | 2-7 | absence | B-6 | 20 | 0.2 | solvent based | 5 | 3H | 5 | Inv. |
| 2-9 | 2-8 | absence | B-7 | 20 | 0.2 | solvent based | 5 | 3H | 5 | Inv. |
| 1-24 | 1-10 | absence | A-1 | 0 | 0.2 | water based | 2 | HB | 2 | Comp. |
| 1-25 | 1-20 | absence | A-3 | 0 | 0.2 | water based | 2 | HB | 2 | Comp. |
| 1-26 | 1-12 | absence | A-4 | 0 | 0.2 | water based | 2 | HB | 2 | Comp. |
| 2-10 | 2-6 | absence | B-1 | 20 | 0.2 | water based | 5 | 3H | 5 | Inv. |
| 2-11 | 2-7 | absence | B-6 | 20 | 0.2 | water based | 5 | 3H | 5 | Inv. |
| 2-12 | 2-8 | absence | B-7 | 20 | 0.2 | water based | 5 | 3H | 5 | Inv. |

*1; Adhesion Property immediately after Development
*2; Abrasion Resistance immediately after Development
*3; Uneven Development
Inv.; Present Invention
Comp.; Comparative Sample

In Table 6, the dried layer thickness of all samples coated with the lower sublayer was 0.2 μm and the polyester ratio of C-2/C-1 was 95/5 (in weight percent).

As can clearly be seen from Table 6, silver salt photothermographic dry imaging material samples (photographic material samples) employing the subbed samples according to the present invention resulted in minimal peeling of the image forming layer from the support as well as minimal abrasion immediately after development and also exhibited minimal uneven development, compared to the comparative samples.

### Example 3

Subbed Samples 3-1 through 3-12 were prepared in the same manner as Subbed Sample 1-1, except that the binder which constituted Upper Subbed Layer A-2 on the light-sensitive later side was varied as shown in Table 7.

Further, Subbed Samples 3-13 through 3-19 were prepared in such a manner that without coating a lower subbed layer, as shown in Table 7, Upper Subbed Layer A-2 was applied onto the surface which had been subjected to a direct corona discharge treatment.

<<Preparation of Solvent Based Silver Salt Photothermographic Dry Imaging Material Samples 3-1 through 3-15>>

As shown in Table 7, Silver Salt Photothermographic Dry Imaging Material Samples 3-1 through 3-15 were prepared in the same manner as Example 1 by providing Subbed Samples 3-1 through 3-15 with the backing layer, the light-sensitive layer, and the surface protective layer.

<<Preparation of Water Based Silver Salt Photothermographic Dry Imaging Material Samples 3-16 through 3-19>>

As shown in Table 7, Silver Salt Photothermographic Dry Imaging Material Samples 3-16 through 3-19 were prepared in the same manner as Example 1 by providing Subbed Samples 3-16 through 3-19 with the backing layer, the light-sensitive layer, and the surface protective layer.

TABLE 7

| | | Light-Sensitive Layer Side | | | | | | | | | | |
|---|---|---|---|---|---|---|---|---|---|---|---|---|
| Photo- | | | Presence or Absence of Lower Layer | | | | | | | | | |
| graphic | | | Binder | | | | | | | | | |
| Material | Subbed | | 1 | Ratio | Binder | Ratio | | | | | | |
| Sample | Sample | Upper | Poly- | Vol. | 2 | Vol. | *1 | Coating | | | | |
| No. | No. | Sublayer | ester | Percent | Type | Percent | μm | Composition | *2 | *3 | *4 | Remarks |
| 1-1 | 1-1 | presence | A-1 | 100 | — | — | 0.2 | solvent based | 3 | F | 3 | Inv. |
| 3-1 | 3-1 | presence | A-1 | 70 | D-1 | 30 | 0.2 | solvent based | 5 | 4H | 5 | Inv. |
| 3-2 | 3-2 | presence | A-1 | 70 | D-2 | 30 | 0.2 | solvent based | 5 | 4H | 5 | Inv. |
| 3-3 | 3-3 | presence | A-1 | 70 | D-3 | 30 | 0.2 | solvent based | 5 | 4H | 5 | Inv. |
| 3-4 | 3-4 | presence | A-1 | 90 | D-5 | 10 | 0.2 | solvent based | 5 | 4H | 5 | Inv. |
| 3-5 | 3-5 | presence | A-1 | 10 | D-5 | 90 | 0.2 | solvent based | 5 | 4H | 5 | Inv. |
| 3-6 | 3-6 | presence | A-1 | 70 | E-1 | 30 | 0.2 | solvent based | 5 | 4H | 5 | Inv. |
| 3-7 | 3-7 | presence | A-1 | 90 | E-2 | 10 | 0.2 | solvent based | 5 | 4H | 5 | Inv. |
| 3-8 | 3-8 | presence | A-1 | 10 | E-2 | 90 | 0.2 | solvent based | 5 | 4H | 5 | Inv. |
| 3-9 | 3-9 | presence | A-1 | 40 | F-1 | 60 | 0.2 | solvent based | 5 | 4H | 5 | Inv. |
| 3-10 | 3-10 | presence | A-1 | 40 | F-2 | 60 | 0.2 | solvent based | 5 | 4H | 5 | Inv. |
| 3-11 | 3-11 | presence | A-1 | 90 | F-3 | 10 | 0.2 | solvent based | 5 | 4H | 5 | Inv. |
| 3-12 | 3-12 | presence | A-1 | 10 | F-3 | 90 | 0.2 | solvent based | 5 | 4H | 5 | Inv. |
| 1-16 | 1-12 | absence | A-4 | 100 | — | — | 0.2 | solvent based | 2 | HB | 2 | Comp. |
| 3-13 | 3-13 | absence | A-4 | 70 | D-4 | 30 | 0.2 | solvent based | 5 | 3H | 2 | Inv. |
| 3-14 | 3-14 | absence | A-4 | 70 | E-2 | 30 | 0.2 | solvent based | 5 | 3H | 2 | Inv. |
| 3-15 | 3-15 | absence | A-4 | 70 | F-3 | 30 | 0.2 | solvent based | 5 | 3H | 5 | Inv. |
| 3-16 | 3-16 | absence | A-2 | 100 | — | — | 0.2 | water based | 2 | HB | 2 | Comp. |
| 3-17 | 3-17 | absence | A-2 | 70 | D-5 | 30 | 0.2 | water based | 5 | 3H | 5 | Inv. |
| 3-18 | 3-18 | absence | A-2 | 70 | E-1 | 30 | 0.2 | water based | 5 | 3H | 5 | Inv. |
| 3-19 | 3-19 | absence | A-2 | 70 | F-3 | 30 | 0.2 | water based | 5 | 3H | 5 | Inv. |

*1; Dried Layer Thickness
*2; Adhesion Property immediately after Development
*3; Abrasion Resistance immediately after Development
*4; Uneven Development
Inv.; Present Invention
Comp.; Comparative Sample

In Table 7, the dried layer thickness of all samples coated with the lower sublayer was 0.2 μm and the polyester ratio of C-2/C-1 was 95/5 (in weight percent).

As can clearly be seen from Table 7, silver salt photothermographic dry imaging material samples (photographic material samples) employing the subbed samples according to the present invention resulted in minimal peeling of the image forming layer from the support as well as minimal abrasion immediately after development and also exhibited minimal uneven development, compared to the comparative samples.

According to the present invention, it is possible to provide silver salt photothermographic dry imaging materials which result in minimal peeling of the image forming layer from the support as well as minimal abrasion immediately after thermal development and also exhibit minimal uneven development specific to thermal development.

What is claimed is:

1. A photothermographic imaging material comprising a support having thereon a sublayer and a photosensitive layer in the order, the photosensitive layer comprising photosensitive silver halide grains, light-insensitive organic silver salt grains, a binder, and a reducing agent for silver ions,
wherein the sublayer comprises:
(i) a first polymer selected from the group consisting of a polyester and a polyester derivative; and
(ii) a second polymer selected from the group consisting of a vinyl polymer latex, a water-soluble polymer containing a vinyl polymer component, a styrene-diolefin copolymer and a polyurethane.

2. The photothermographic imaging material of claim 1, wherein the second polymer is a vinyl polymer latex.

3. The photothermographic imaging material of claim 2, wherein the first polymer is a polyester derivative which is modified with a vinyl monomer.

4. The photothermographic imaging material of claim 3,
wherein a content of the vinyl monomer in the polyester derivative is at least 10 weight % based on the total weight of the polyester derivative.

5. The photothermographic imaging material of claim 1,
wherein the second polymer is a water-soluble polymer containing a vinyl polymer component.

6. The photothermographic imaging material of claim 1,
wherein the second polymer is a styrene-diolefin copolymer.

7. The photothermographic imaging material of claim 1,
wherein the second polymer is a polyurethane.

8. The photothermographic imaging material of claim 1,
wherein the sublayer further comprises an inorganic filler.

9. A photothermographic imaging material comprising a support having thereon a sublayer and a photosensitive layer in the order, the photosensitive layer comprising photosensitive silver halide grains, light-insensitive organic silver salt grains, a binder, and a reducing agent for silver ions,
wherein the sublayer comprises a polyester which is derived from a naphthalene dicarboxylic acid and an alcohol.

10. The photothermographic imaging material of claim 9,
wherein the sublayer further comprises an inorganic filler.
